(19) United States
(12) Patent Application Publication
(10) Pub. No.: US 2016/0115347 A1
(43) Pub. Date: Apr. 28, 2016

(54) RESOLE PHENOLIC RESINS CURABLE WITH FUNCTIONAL POLYESTERS

(71) Applicant: Eastman Chemical Company, Kingsport, TN (US)

(72) Inventors: Thauming Kuo, Kingsport, TN (US); Junjia Liu, Kingsport, TN (US); Phillip Bryan Hall, Jonesborough, TN (US)

(73) Assignee: Eastman Chemical Company, Kingsport, TN (US)

(21) Appl. No.: 14/922,846

(22) Filed: Oct. 26, 2015

Related U.S. Application Data
(63) Continuation-in-part of application No. 14/683,278, filed on Apr. 10, 2015.
Application No. 14/683,278 is a continuation-in-part of application No. 14/524,509, filed on Oct. 27, 2014.
Application No. 14/524,509 is a continuation-in-part of application No. 14/524,514, filed on Oct. 27, 2014.
Application No. 14/524,514 is a continuation-in-part of application No. 14/540,490, filed on Nov. 13, 2014.
Application No. 14/683,278 is a continuation-in-part of application No. 14/524,509, filed on Oct. 27, 2014.
Application No. 14/524,509 is a continuation-in-part of application No. 14/524,514, filed on Oct. 27, 2014.
Application No. 14/524,514 is a continuation-in-part of application No. 14/540,490, filed on Nov. 13, 2014.

(51) Int. Cl. C09D 167/02; C08L 67/02; C08L 61/06; C08G 8/08

(52) U.S. Cl. CPC C09D 167/02; C08G 8/08; C08L 67/02; C08L 61/06; C08L 2201/54; C08L 2201/56

(57) ABSTRACT

This invention relates to a resole phenolic resin comprising the residues of
(a) from about 50 to 100 mole % of a meta-substituted phenol [phenolic component (a)],
(b) from 0 to about 50 mole % of at least one phenolic component [phenolic component (b)] other than said meta-substituted phenol, and
(c) from about 150 to about 300 mole % of at least one aldehyde,
wherein the mole percentages of said phenolic components (a) and (b) are based on the total moles of phenolic components (a) and (b);
wherein the mole percentages of said aldehyde component is based on the total moles of said phenolic components (a) and (b), and
wherein said resole phenolic resin is soluble in an organic solvent and curable with a functional polyester.

### CROSS-REFERENCE TO RELATED APPLICATIONS

This application is a continuation-in part of and claims priority to:
(I) U.S. application Ser. No. 14/683,278 filed on Apr. 10, 2015, and
(II) U.S. application Ser. No. 14/524,509 filed on Oct. 27, 2014, and
(III) U.S. application Ser. No. 14/524,514 filed on Oct. 27, 2014, and
(IV) U.S. application Ser. No. 14/540,490 filed on Nov. 13, 2014, and

each of which are each incorporated fully herein by reference.

### FIELD OF THE INVENTION

This invention pertains to resole curable phenolic resins based on m-substituted phenol that are soluble and curable with polyesters having a variety of functionalities. The resole phenolic resins can be formulated with functional polyesters for thermoset applications. The thermosetting compositions of the invention can have utility in solvent-based coatings as well as waterborne coatings.

### BACKGROUND OF THE INVENTION

Metal containers are commonly used for food and beverage packaging. The containers are typically made of steel or aluminum. A prolonged contact between the metal and the filled product can lead to corrosion of the container. To prevent direct contact between filled product and metal, a coating is typically applied to the interior of the food and beverage cans. In order to be effective, such a coating must have adequate properties that are needed for protecting the packaged products, such as adhesion, corrosion resistance, chemical resistance, flexibility, stain resistance, and hydrolytic stability. Moreover, the coating must be able to withstand processing conditions during can fabrication and food sterilization.

Coatings based on a combination of epoxy and phenolic resins are known to be able to provide a good balance of the required properties and are most widely used. There are industry sectors moving away from food contact polymers made with bisphenol A (BPA) and bisphenol A diglycidyl ether (BADGE), which are the building blocks of the epoxy resins. Thus, there exists a desire for the replacement of epoxy resin used in interior can coatings.

Polyesters have been of particular interest to the coating industry to be used as a replacement for epoxy resin because of their comparable properties such as flexibility and adhesion. Crosslinking between polyester and common phenolic resin generally is too poor to provide adequate properties for use in interior can coatings. Specifically, conventional polyesters having hydroxyl functionalities are generally not reactive enough with commercially available phenolic resins under curing conditions to provide adequate cross-linking density, resulting in a coating that lacks good solvent resistance and other desirable properties.

Conventional polyester does not have functionality that is capable of reacting with aromatic hydroxyl groups present in phenolic resins. Thus, there exists a need to redesign polyesters that do have functionality that is capable of reacting with aromatic hydroxyl groups to achieve the desirable coating properties.

### SUMMARY OF THE INVENTION

This invention provides polyesters that have functionality that is capable of reacting with aromatic hydroxyl group.

In one embodiment, this invention provides a resole phenolic phenolic resin comprising the residues of
(a) from about 50 to 100 mole % of a meta-substituted phenol [phenolic component (a)],
(b) from 0 to about 50 mole % of at least one phenolic component [phenolic component (b)] other than said meta-substituted phenol, and
(c) from about 150 to about 300 mole % of at least one aldehyde,
wherein the mole percentages of said phenolic components (a) and (b) are based on the total moles of phenolic components (a) and (b);
wherein the mole percentages of said aldehyde component is based on the total moles of said phenolic components (a) and (b), and
wherein said resole phenolic resin is soluble in an organic solvent and curable with a functional polyester.

In another embodiment, there is provided a thermosetting composition comprising:
I) the resole phenolic resin of the present disclosure and
II) at least one curable polyester resin which has one or more functionalities selected from the group comprising hydroxyl, carboxyl, α,β-unsaturated dicarboxylate, beta-ketoacetate, carbamate, phenol, amino, and maleimide groups.

The curable polyester resin useful in the invention can comprise the residues of

a) polyhydroxyl compounds comprising:
i) 2,2,4,4-tetraalkylcyclobutane-1,3-diol (TACD) compounds, and
ii) polyhydroxyl compounds other than TACD, and

b) polycarboxyl compounds comprising:
i) a polycarboxylic acid compound, a derivative of polycarboxylic acid compound (other than (bii)), or a combination thereof, and
ii) a polycarboxylic anhydride compound;
   wherein said curable polyester resin has an acid number ranging from about 20 to about 120 mg KOH/g, a hydroxyl number ranging from greater than 0 to about 100 mg KOH/g, and an acid number:hydroxyl (AN:OH) number ratio of at least 0.5:1.

The curable polyester resin useful in the invention comprise the residues of:

a) polyhydroxyl compounds comprising:
i) 2,2,4,4-tetraalkylcyclobutane-1,3-diol (TACD) compounds in an amount ranging from about 3 to 98 mole %, based on the total moles of polyhydroxyl compounds (a), and
ii) polyhydroxyl compounds other than TACD comprising
   (1) a diol in an amount ranging from 0 to 95 mole %, based on the total moles of (a), and
   (2) a polyhydroxyl compound having 3 or more hydroxyl groups in an amount ranging from 2 to 20 mole %, based on the total moles of (a), and

b) polycarboxyl compounds comprising
i) a polycarboxylic acid, a derivative of polycarboxylic acid compound (other than bii)), or a combination thereof in an amount ranging from 70 to 95 mole %, based on the total moles of (b), and
ii) a polycarboxylic anhydride in an amount ranging from 5 to 30 mole %, based on the total moles of (b),
   wherein said polyester has an acid number ranging from about 30 to about 100 mg KOH/g and a hydroxyl number ranging from 3 to about 80 mg KOH/g.

If desired, this polyester can have an acid number:hydroxyl number ratio of at least 0.5:1.

There is also provided a method for making a curable polyester resin composition comprising:
a) in a first stage, combining the polyhydroxyl compounds and polycarboxylic acid compounds to form a reaction mixture, and reacting the reaction mixture in a reactor at a temperature from 180-250° C., optionally in the presence of an acid catalyst until the reaction mixture has an acid number of 0 to 20 mg KOH/g, and
b) thereafter, a second stage for forming a curable polyester composition by reacting a polycarboxylic anhydride with the reaction mixture at a temperature of 140° C. to 180° C. to thereby obtain a polyester composition having an acid number of greater than 20 mg KOH/g.

The meta-substituted phenol useful in the resole phenolic resin useful in the present disclosure can be selected from at least one from the group comprising m-cresol, m-ethylphenol, m-propylphenol, m-butylphenol, m-octylphenol, m-alkylphenol, m-phenylphenol, m-alkoxyphenol, 3,5-xylenol, 3,5-diethyl phenol, 3,5-dibutyl phenol, 3,5-dialkylphenol, 3,5-dialkoxyphenol, 3,5-dicyclohexyl phenol, 3,5-dimethoxy phenol, and 3-alkyl-5-alkyoxy phenol.

The meta-substituted phenol useful in the resole phenolic resin useful in the present disclosure can be m-cresol.

Phenolic component (b) useful in the present disclosure can be ortho-substituted, para-substituted, or unsubstituted phenol, or a mixture thereof.

Phenolic component (b) useful in the present disclosure can be ortho-substituted, or para-substituted phenol, or a mixture thereof.

Phenolic component (b) useful in the present disclosure can be selected from one or more selected from the group comprising o-cresol, o-ethylphenol, o-propylphenol, o-n-butylphenol, o-t-butyl phenol, o-octylphenol, o-phenylphenol, p-cresol, p-ethylphenol, p-propylphenol, p-n-butylphenol, p-t-butyl phenol, p-octylphenol, p-phenylphenol, 2,3-xylenol, 2,3-diethyl phenol, 2,3-dibutyl phenol, 2,5-xylenol, 2,5-diethyl phenol, 2,5-dibutyl phenol, 3,4-xylenol, 3,4-diethyl phenol, and 3,4-dibutyl phenol.

Phenolic component (b) useful in the present disclosure can be selected from o-cresol, p-cresol, and a mixture thereof.

The aldehyde useful in the resole phenolic resin of the present disclosure can be selected from formaldehyde, acetaldehyde, propionaldehyde, furfuraldehyde, benzaldehyde, and a mixture thereof.

The aldehyde useful in the resole phenolic resin of the present disclosure cab be formaldehyde.

The resole phenolic resin of the present disclosure can be soluble in one or more organic solvents selected from the group comprising xylene, toluene, acetone, methyl ethyl ketone, methyl isobutyl ketone, methyl n-amyl ketone, methyl isoamyl ketone, n-butyl acetate, isobutyl acetate, t-butyl acetate, n-propyl acetate, isopropyl acetate, ethyl acetate, methyl acetate, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, Aromatic 100 Fluid (ExxonMobil), or Aromatic 150 Fluid (ExxonMobil).

In one embodiment, the resole phenolic resin comprises the meta-substituted phenol (a) in an amount of from 70 to 100 mole % and the phenolic component (b) in an amount of from 0 to 30 mole %.

In one embodiment, the resole phenolic resin comprises the meta-substituted phenol (a) in an amount of from 90 to 100 mole % and the phenolic component (b) in an amount of from 0 to 10 mole %.

In one embodiment, the resole phenolic resin comprises the meta-substituted phenol (a) in the amount of 100 mole %.

In one embodiment, the resole phenolic resin comprises at least one aldehyde in the amount of from 170 to 270 mole % of an aldehyde, based on the total moles of phenolic components, (a) and (b).

In some embodiments, the resole phenolic resin can contain an average of at least 0.5 or 0.7 methylol groups (including either or both of —CH₂OH and —CH₂OR) per one phenolic hydroxyl group.

In one embodiment, the resole phenolic resin comprises a functional polyester having a functionality selected from hydroxyl, carboxyl, α,β-unsaturated dicarboxylate, beta-ketoacetate, carbamate, phenol, amino, maleimide, or a combination thereof.

In one embodiment, there is provided a thermosetting composition comprising:
I) at least one resole phenolic resin as described in the present disclosure and
II) a curable polyester which has one or more functionalities selected from the group comprising hydroxyl, carboxyl, α,β-unsaturated dicarboxylate, beta-ketoacetate, carbamate, phenol, amino, and maleimide groups.

The thermosetting composition of the present disclosure can further comprise one or more acid catalysts selected from the group comprising p-toluenesulfonic acid, dinonylnaphthalene disulfonic acid, dodecylbenzenesulfonic acid, and phosphoric add.

The thermosetting composition of the present disclosure can further comprise phosphoric acid catalyst.

The thermosetting composition of the present disclosure can further comprise phosphoric acid catalyst in an amount ranging from 0.8 to 1.2 weight % based on the total weight of the resole phenolic resin (I) and the curable polyester (II).

The thermosetting composition of the present disclosure can contain the resole phenolic resin (I) in an amount from 20 to 50 weight % and the curable polyester (II) in an amount from 50 to 80 weight % based on the total weight of (I) and (II).

The thermosetting composition of the present disclosure can contain at least one curable polyester having a cumulative hydroxyl number and an acid number in a range of 3 to 280 mg KOH/g.

In one embodiment, the thermosetting composition of the present disclosure can contain at least one curable polyester having a cumulative hydroxyl number and acid number in a range of 30 to 150 mg KOH/g.

In one embodiment, the thermosetting composition of the present disclosure can contain at least one curable polyester having a hydroxyl number ranging from 30 to 150 mg KOH/g.

In one embodiment, the thermosetting composition of the present disclosure can contain at least one curable polyester having functionalities comprising α,β-unsaturated dicarboxylate group.

In one embodiment, the thermosetting composition of the present disclosure can contain at least one curable polyester having functionalities comprising beta-ketoacetate group.

In one embodiment, the thermosetting composition of the present disclosure can contain at least one curable polyester having functionalities comprising carbamate group.

In one embodiment, the thermosetting composition of the present disclosure can contain at least one curable polyester having functionalities comprising at least one phenol group.

In one embodiment, the thermosetting composition of the present disclosure can contain at least one curable polyester having functionalities comprising at least one amino group.

In one embodiment, the thermosetting composition of the present disclosure can contain at least one curable polyester having functionalities comprising at least one maleimide group.

In one embodiment, the thermosetting composition of the present disclosure can contain at least one curable polyester comprising the residues of:
a) polyhydroxyl compounds comprising:
   (i) diol compounds in an amount of 70 mole % to 100 mole % and
   (ii) polyhydroxyl compounds having 3 or more hydroxyl groups in an amount of 0 to 30 mole %,
   wherein the mole % is based on 100% of all moles of polyhydroxyl compounds a); and
b) polycarboxyl compounds comprising polycarboxylic acid compounds, derivatives of polycarboxylic acid compounds, the anhydrides of polycarboxylic acids, or combinations thereof.

In one embodiment, the thermosetting composition of the present disclosure can further comprise one or more organic solvents selected from the group comprising xylene, toluene, acetone, methyl ethyl ketone, methyl isobutyl ketone, methyl n-amyl ketone, methyl isoamyl ketone, n-butyl acetate, isobutyl acetate, t-butyl acetate, n-propyl acetate, isopropyl acetate, ethyl acetate, methyl acetate, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, Aromatic 100 Fluid (ExxonMobil), Aromatic 150 Fluid (ExxonMobil), or mixtures thereof.

The present disclosure further provides a resole aqueous dispersion comprising

I. the resole phenolic resin of the present disclosure,

II. a neutralizing agent, and

III. water

In the resole aqueous dispersion of the present disclosure the neutralizing agent can be selected from ammonium hydroxide, triethylamine, N,N-dimethylethanolamine, 2-amino-2-methyl-1-propanol, and a mixture thereof.

The present disclosure also provides a waterborne thermosetting composition comprising
I. the resole aqueous dispersion of the present disclosure and
II. at least one waterborne curable polyester having one or more functionalities selected from the groups comprising hydroxyl, carboxyl, α,β-unsaturated dicarboxylate, beta-ketoacetate, carbamate, phenol, amino, and maleimide groups, for example, residues of 2,2,4,4-tetraalkylcyclobutane-1,3-diol (TACD) or residues of 2,2,4,4-tetramethylcyclobutane-1,3-diol (TMCD).

In one embodiment, there is provided a coating made from the thermosetting composition of present disclosure.

In certain embodiments, the thermosetting composition can further comprise aminoplast crosslinker, isocyanate crosslinker, and/or epoxy crosslinker.

Also provided is a method for the preparation of the resole phenolic resin of the present disclosure, comprising the steps of
a. combining meta-substituted phenol and other phenolic compounds if used with formaldehyde water solution (formalin) in a reactor,
b. adjusting the pH of the mixture with a base to be about 9.5 to about 10.5,
c. heating the stirred mixture to a temperature from about 55° C. to about 65° C.,
d. allowing the mixture to react for about one to about ten hours,
e. neutralizing the resulting mixture upon cooling with an acid to a pH of about 6.5 to about 7.5, and
f. working up the crude product thus obtained to purify and isolate the resole phenolic resin;

wherein said steps are sequential in the order listed and begin with step (a).

In the method for the preparation of the resole phenolic resin of the present disclosure, the pH in step (b) can be from 9.6 to 10.2, the temperature in step (c) can be from 58° C. to about 62° C., and the reaction time in step (d) can be two to five hours.

The curable polyester resins of the present disclosure can be used in several end-use applications as may be apparent to one of ordinary skill in the art. Some examples of these end-use applications are water borne coatings, solvent borne coatings, or powder coatings. Such coatings can be used in automotive OEM, auto refinish, transportation, aerospace, maintenance, marine, machinery and equipment, general metal, appliance, metal furniture, commercial construction, home construction, architectural coating applications, paints, packaging such as metal can coatings, and coil.

### DETAILED DESCRIPTION OF THE INVENTION

Unless otherwise indicated, all numbers expressing quantities of ingredients, properties such as molecular weight, reaction conditions, and so forth used in the specification and claims are to be understood as being modified in all instances by the term “about.” Unless indicated to the contrary, the numerical parameters set forth in the following specification and attached claims are approximations that may vary depending upon the desired properties. At the very least, each numerical parameter should be construed in light of the number of reported significant digits and by applying ordinary rounding techniques. Further, the ranges stated in this disclosure and the claims are intended to include the entire range specifically and not only the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ alkyl groups” is intended to specifically include and disclose C₁ and C₅ alkyl groups as well as C₂, C₃, and C₄ alkyl groups.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

As used in the specification and the appended claims, the singular forms “a,” “an” and “the” include their plural referents unless the context clearly dictates otherwise. For example, a reference to a “polyester,” a “polycarboxylic acid”, a “residue” is synonymous with “at least one” or “one or more” polyesters, polycarboxylic acids, or residues and is thus intended to refer to both a single or plurality of polyesters, polycarboxylic acids, or residues. In addition, references to a composition containing or including “an” ingredient or “a” polyester is intended to include other ingredients or other polyesters, respectively, in addition to the one named. The terms “containing” or “including” are intended to be synonymous with the term “comprising”, meaning that at least the named compound, element, particle, or method step, etc., is present in the composition or article or method, but does not exclude the presence of other compounds, catalysts, materials, particles, method steps, etc, even if the other such compounds, material, particles, method steps, etc., have the same function as what is named, unless expressly excluded in the claims.

Also, it is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

The phrase “at least a portion” includes a portion or the whole.

Phenolic resins having methylol (—CH₂OH) functionalities on the phenolic rings are referred to as resole type phenolic resins. Below is a representative structure of a resole phenolic resin.

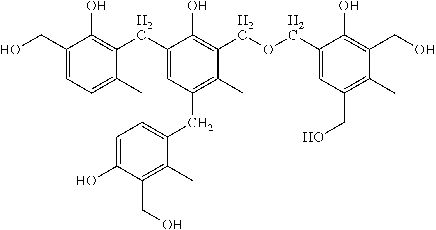 [SMILES: Cc1ccc(CO)c(O)c1Cc1cc(Cc2ccc(O)c(CO)c2C)c(C)c(COCc2cc(CO)c(C)c(CO)c2O)c1O]

For the purposes of this disclosure, a resole resin is an oligomeric material containing phenolic rings linked predominantly by either methylene or methylene ether group. Because the linkages can be of different type and be on either ortho, para, or both, and the number of phenolic rings can vary, the resole resin is a mixture of numerous small molecules and oligomers having, for example, one to four rings or more. Possible structures of resoles based on cresol and phenol are reported in the reference—Biedermann, M., & Grob, K. “Phenolic resins for can coatings: II. Resoles based on cresol/phenol mixtures or tert-butyl phenol” LWT—Food Science and Technology 39 (2006) 647-659 (Elsevier). The resole samples are reported to be based on predominantly o- or p-cresol and phenol; they are found to contain molecules with one to four rings at a ratio of about 2/3 with the rest being higher molecular weight molecules.

As is known in the art, the resole type phenolic resin is prepared by the reaction of a phenol compound including substituted and unsubstituted phenols) and an aldehyde at an aldehyde:phenol molar ratio of greater than 1:1, for example 1.5:1.0, 2.0:1.0, or 3.0:1.0. Said molar ratio can greatly affect the properties of the resulting resole resin, such as solubility and the number of methylol functionality. On the one hand, while higher ratio can provide the resulting resole resin with higher molecular weight and more methylol functional groups, the resin could have poor solubility or even form an insoluble solid mass during synthesis due to gelation. On the other hand, lower ratio can lead to low molecular weight and less functionality, which would have negative impact on the coating properties. Moreover, the type of the phenol compounds used can also affect the resole resin properties. Unsubstituted phenol is suitable for making resole phenolic resin, but it is not desirable for interior can coating applications since its resulting resole resin can contain bisphenol F (BPF) residue, which is a health concern. Meta-substituted phenol is desirable as compared to ortho- or para-substituted since it can provide three reaction sites for methylol formation; however, it can also lead to poor solubility or gelation during preparation. The alkyl or alkoxy substituents on the meta-substituted phenol can enhance the reactivity of phenol. Such reactivity-enhancing substituents coupled with three reactive sites often lead to difficulty in synthesis and yield products that cannot be formulated into coating compositions. Because of all these obstacles in working out a soluble resole phenolic resin that is crosslinkable with functional polyesters, there remains a need in the industry for a novel resole resin that is free of BPF.

In one embodiment, this invention provides a resole phenolic resin comprising the residues of
(a) from about 50 to 100 mole % of a meta-substituted phenol [phenolic component (a)],
(b) from 0 to about 50 mole % of at least one phenolic component [phenolic component (b)] other than said meta-substituted phenol, and
(c) from about 150 to about 300 mole % of at least one aldehyde,
wherein the mole percentages of said phenolic components (a) and (b) are based on the total moles of phenolic components (a) and (b);
wherein the mole percentages of said aldehyde component is based on the total moles of said phenolic components (a) and (b), and
wherein said resole phenolic resin is soluble in an organic solvent and curable with a functional polyester.

Examples of meta-substituted phenols (a) include m-cresol, m-ethylphenol, m-propylphenol, m-butylphenol, m-octylphenol, m-alkylphenol, m-phenylphenol, m-alkoxyphenol, 3,5-xylenol, 3,5-diethyl phenol, 3,5-dibutyl phenol, 3,5-dialkylphenol, 3,5-dialkoxyphenol, 3,5-dicyclohexyl phenol, 3,5-dimethoxy phenol, 3-alkyl-5-alkyoxy phenol, and the like.

Examples of phenolic component (b) (a phenolic component other than meta-substituted phenol) in the resole phenolic resin of the disclosure include ortho-substituted, para-substituted, and unsubstituted phenols. Said unsubstituted phenol can be phenol compound itself without any substituents (C₆H₅OH), or dihydroxybenzenes such as resorcinol and catechol, or trihydroxybenzenes such as hydroxyquinol and phloroglucinol. Said o-substituted phenols include o-cresol, o-ethylphenol, o-propylphenol, o-n-butylphenol, o-t-butyl phenol, o-octylphenol, o-alkylphenol, o-phenylphenol, o-alkoxyphenol, 2,3-xylenol, 2,3-diethyl phenol, 2,3-dibutyl phenol, 2,3-dialkylphenol, 2,3-dialkoxyphenol, 2,3-dicyclohexyl phenol, 2,3-dimethoxy phenol, 2-alkyl-3-alkoxy phenol, 2,5-xylenol, 2,5-diethyl phenol, 2,5-dibutyl phenol, 2,5-dialkylphenol, 2,5-dialkoxyphenol, 2,5-dicyclohexyl phenol, 2,5-dimethoxy phenol, 2-alkyl-5-alkoxy phenol, and the like. Said p-substituted phenols include p-cresol, p-ethylphenol, p-propylphenol, p-n-butylphenol, p-t-butyl phenol, p-octylphenol, p-alkylphenol, p-phenylphenol, p-alkoxyphenol, 3,4-xylenol, 3,4-diethyl phenol, 3,4-dibutyl phenol, 3,4-dialkylphenol, 3,4-dialkoxyphenol, 3,4-dicyclohexyl phenol, 3,4-dimethoxy phenol, 3-alkyl-4-alkyoxy phenol, and the like.

The at least one aldehyde of component (c) can have the general formula RCHO, where R is hydrogen or a hydrocarbon group having 1 to 8 carbon atoms. Specific examples include formaldehyde, acetaldehyde, propionaldehyde, furfuraldehyde, or benzaldehyde. In one embodiment, the aldehyde can be formaldehyde.

The mole % of m-substituted phenol (a) can be from about 50 to 100 mole % based on the total moles of phenolic components (a) and (b), or from 55 to 100, or from 60 to 100, or from 65 to 100, or from 70 to 100, or from 75 to 100, or from 80 to 100, or from 85 to 100, or from 90 to 100, or from 95 to 100 mole %.

The mole % of phenolic component (b) can be from 0 to about 50 mole % based on the total moles of phenolic components (a) and (b), or from 0 to 45, or from 0 to 40, or from 0 to 35, or from 0 to 30, or from 0 to 25, or from 0 to 20, or from 0 to 15, or from 0 to 10, or from 0 to 5 mole %.

The mole % of aldehyde (c) based on the total moles of the phenolic compounds, (a) and (b), can be from about 150 to about 300, or from about 160 to about 280, or from about 170 to about 270, or from about 175 to about 265, or from about 180 to about 260, or from about 200 to about 255, or from about 230 to about 250.

The resole phenolic resin of this disclosure has methylol (—CH₂OH) functionality available for crosslinking. As is known in the art, the methylol group may be etherated with an alcohol and present as —CH₂OR, wherein R is C1-C8 alkyl group, in order to improve resin properties such as storage stability, solubility, and compatibility. For purpose of the description, the term “methylol” used herein includes both —CH₂OH and —CH₂OR. The resole resin desirably contains an average of at least 0.5 methylol groups per one phenolic hydroxyl (Ar—OH) group, more desirably at least 0.7 methylol groups, and most desirably at least 0.8 methylol groups.

The resole phenolic resin of the present disclosure can be heat curable. In one embodiment, the resole phenolic resin is not made by the addition of bisphenol A, F, or S (collectively “BPA”).

The resole resin can be liquid at 25° C. The resole resin can have a number average molecular weight of from 300 to 1500.

The resole resin of the present invention is soluble in one or more organic solvents selected from the group comprising benzene, xylene, mineral spirits, naphtha, toluene, acetone, methyl ethyl ketone, methyl isobutyl ketone, methyl n-amyl ketone, methyl isoamyl ketone, n-butyl acetate, isobutyl acetate, t-butyl acetate, n-propyl acetate, isopropyl acetate, ethyl acetate, methyl acetate, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, 2,2,4-trimethyl-1,3-pentanediol monoisobutyrate, Aromatic 100 Fluid (ExxonMobil), Aromatic 150 Fluid (ExxonMobil), and combinations thereof. For the purposes of this invention, when a resin is soluble in a solvent, it forms a solution with the solvent which is substantially free of insoluble substance. It is within the scope of this invention if less than 20%, or less than 15%, or less than 10%, or less than 5%, or less than 4%, or less than 3%, or less than 2%, or less than 1%, or less than 0.5%, or less than 0.1%, of the resin remains insoluble in the solvent. In one embodiment, less than 5%, or less than 4%, or less than 3%, or less than 2%, or less than 1%, or less than 0.5%, or less than 0.1%, by weight of the resin remains insoluble in the solvent. For the purposes of clarity, for a resin having less than 1% by weight of solubility in a solvent, there is less than 1 g resin per 100 g of solvent. In one embodiment, the resulting solution can be visually clear.

The resole phenolic resin of the invention can be prepared by a process comprising the steps of
I. combining meta-substituted phenol and other phenolic compounds if used with formaldehyde water solution (formalin) in a reactor,
II. adjusting the pH of the mixture with a base to be about 9.5 to about 10.5,
III. heating the stirred mixture to a temperature from about 55° C. to about 65° C.,
IV. allowing the mixture to react for about one to about ten hours,
V. neutralizing the resulting mixture upon cooling with an acid to a pH of about 6.5 to about 7.5, and
VI. working up the crude product thus obtained to purify and isolate the resole phenolic resin.

In one embodiment, in the process of making the resole phenolic resin of the present disclosure, the pH in step (II) can be from 9.6 to 10.2 or from 9.7 to 10.0; the temperature in step (III) can be 58° C. to about 62° C.; and/or the reaction time in step (IV) can be two to five hours.

The resole resin of the present disclosure can be crosslinkable with polyesters having a variety of functionalities. Such polyesters are also referred to as “functional polyesters” throughout the description of this invention. Below is a schematic diagram depicting the reaction of resole phenolic resin and hydroxyl-functional polyester through a reactive quinone methide intermediate. Polyesters having other functionalities described herein can also undergo crosslinking reaction through the quinone methide intermediate.

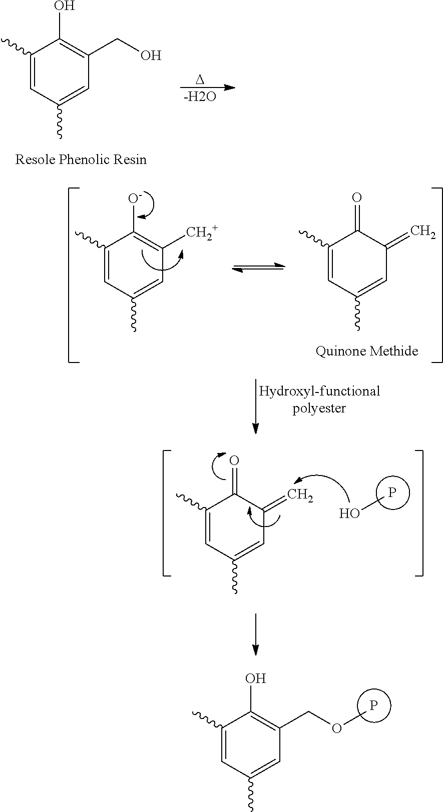

Thus, in another embodiment, there is provided a thermosetting composition comprising:
I) the resole phenolic resin of the present invention and
II) a curable polyester which has one or more functionalities selected from the group comprising hydroxyl, carboxyl, α,β-unsaturated dicarboxylate, beta-ketoacetate, carbamate, phenol, amino, and maleimide groups.

The resole phenolic resin (I) can be present in an amount from about 10 to about 90 wt. % based on the total weight of (I) and (II), or from 20 to 80 wt. %, or from 30 to 70 wt. %, from 40 to 60 wt. %, from 20 to 50 wt. %, from 20 to 40 wt. %, or from 20 to 30 wt. %. The curable polyester can be present in an amount from about 10 to about 90 wt. % based on the total weight of (I) and (II), or from 20 to 80 wt. %, or from 30 to 70 wt. %, from 40 to 60 wt. %, from 50 to 80 wt. %, from 60 to 80 wt. %, or from 70 to 80 wt. %.

The curable polyester (II) can have a functionality of hydroxyl, carboxyl, α,β-unsaturated dicarboxylate, beta-ketoacetate, carbamate, phenol, amino, and/or maleimide. Desirably, the functionality is hydroxyl, carboxyl, α,β-unsaturated dicarboxylate, or beta-ketoacetate. Hydroxyl and carboxyl groups are commonly present in said curable polyester.

The functional polyesters described in this invention are either modified from a conventional hydroxyl- or carboxyl-functional polyester or synthesized with a monomer having the desirable functionality. For example, beta-ketoacetate- and maleimide-functional polyester can be synthesized by modifying from a hydroxyl functional polyester, the carbamate functional polyester from either a carboxyl functional or a hydroxyl functional polyester, and the amino functional polyester from an unsaturated polyester, whereas the α,β-unsaturated dicarboxylate functional polyester can be synthesized by incorporating a functional monomer such as, for example, maleic anhydride.

Polyesters having hydroxyl and/or carboxyl functionalities can be prepared by reacting a polyhydroxyl compound with a polycarboxyl compound. Such a polyester suitable for this invention comprises the residues of

a) polyhydroxyl compounds comprising:
(i) diol compounds in an amount of 70 mole % to 100 mole % and
(ii) polyhydroxyl compounds having 3 or more hydroxyl groups in an amount of 0 to 30 mole %,
wherein the mole % is based on 100% of all moles of polyhydroxyl compounds a); and
   b) polycarboxyl compounds comprising polycarboxylic acid compounds, derivatives of polycarboxylic acid compounds, the anhydrides of polycarboxylic acids, or combinations thereof.

For purposes of calculating quantities, all compounds having at least one hydroxyl group are counted as polyhydroxyl compounds (a). Such compounds include, but are not limited to, mono-ols, diols, polyhydroxyl compounds having 3 or more hydroxyl groups, and for each of the foregoing, can be hydrocarbons of any chain length optionally containing ether groups such as polyether polyols, ester groups such as polyesters polyols, and amide groups.

The diols (a)(i) have two hydroxyl groups and can be branched or linear, saturated or unsaturated, aliphatic or cycloaliphatic C₂-C₂₀ compounds, the hydroxyl groups being primary, secondary, and/or tertiary. Desirably, the polyhydroxyl compounds are hydrocarbons and do not contain atoms other than hydrogen, carbon and oxygen. Examples of diols (a)(i) include 2,2,4,4-tetraalkylcyclobutane-1,3-diol (TACD), 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, tetraethylene glycol, and polyethylene glycol.

The TACD compound can be represented by the general structure (1):

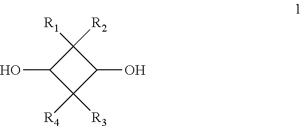

wherein R₁, R₂, R₃, and R₄ each independently represent an alkyl radical, for example, a lower alkyl radical having 1 to 8 carbon atoms; or 1 to 6 carbon atoms, or 1 to 5 carbon atoms, or 1 to 4 carbon atoms, or 1 to 3 carbon atoms, or 1 to 2 carbon atoms, or 1 carbon atom. The alkyl radicals may be linear, branched, or a combination of linear and branched alkyl radicals. Examples of TACD include 2,2,4,4-tetramethylcyclobutane-1,3-diol (TMCD), 2,2,4,4-tetraethylcyclobutane-1,3-diol, 2,2,4,4-tetra-n-propylcyclobutane-1,3-diol, 2,2,4,4-tetra-n-butylcyclobutane-1,3-diol, 2,2,4,4-tetra-n-pentylcyclobutane-1,3-diol, 2,2,4,4-tetra-n-hexylcyclobutane-1,3-diol, 2,2,4,4-tetra-n-heptylcyclobutane-1,3-diol, 2,2,4,4-tetra-n-octylcyclobutane-1,3-diol, 2,2-dimethyl-4,4-diethylcyclobutane-1,3-diol, 2-ethyl-2,4,4-trimethylcyclobutane-1,3-diol, 2,4-dimethyl-2,4-diethyl-cyclobutane-1,3-diol, 2,4-dimethyl-2,4-di-n-propylcyclobutane-1,3-diol, 2,4-n-dibutyl-2,4-diethylcyclobutane-1,3-diol, 2,4-dimethyl-2,4-diisobutylcyclobutane-1,3-diol, and 2,4-diethyl-2,4-diisoamylcyclobutane-1,3-diol.

Desirably, the diol (a)(i) is 2,2,4,4-tetramethylcyclobutane-1,3-diol (TMCD), 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 1,4-butanediol, and 1,6-hexanediol or mixtures thereof. Desirably, at least one of the diols (a)(i) is TMCD.

The diols (a)(i) are desirably present in an amount of at least 70 mole %, or at least 75 mole %, or at least 80 mole %, or at least 85 mole %, or at least 87 mole %, or at least 90 mole %, or at least 92 mole %, based on 100 mole % of all polyhydroxyl compounds. Additionally or in the alternative, the diols (a)(i) can be present in an amount of up to 100 mole %, or up to 98 mole %, or up to 96 mole %, or up to 95 mole %, or up to 93 mole %, or up to 90 mole %, based on 100 mole % of all polyhydroxyl compounds. Suitable ranges include, in mole % based on 100 mole % of all polyhydroxyl compounds (a), 70-100, or 75-100, or 80-100, or 85-100, or 87-100, or 90-100, or 92-100, or 95-100, or 96-100, or 70-98, or 75-98, or 80-98, or 85-98, or 87-98, or 90-98, or 92-98, or 95-93, or 96-93, or 70-93, or 75-93, or 80-93, or 85-93, or 87-93, or 90-93, or 92-93, or 70-90, or 75-90, or 80-90, or 85-90, or 87-90.

The polyhydroxyl compounds (a)(ii) having three or more hydroxyl groups can be branched or linear, saturated or unsaturated, aliphatic or cycloaliphatic C₂-C₂₀ compounds, the hydroxyl groups being primary, secondary, and/or tertiary, and desirably at least two of the hydroxyl groups are primary. Desirably, the polyhydroxyl compounds are hydrocarbons and do not contain atoms other than hydrogen, carbon and oxygen. Examples of the polyhydroxyl compounds (a)(ii) include 1,1,1-trimethylol propane, 1,1,1-trimethylolethane, glycerin, pentaerythritol, erythritol, threitol, dipentaerythritol, sorbitol, mixtures thereof, and the like.

The polyhydroxyl compounds (a)(ii), if present, can be present in an amount of at least 1 mole %, or at least 2 mole %, or at least 5 mole %, or at least 8 mole %, or at least 10 mole %, based on 100 mole % of all polyhydroxyl compounds (a). Additionally or in the alternative, the polyhydroxyl compounds (a)(ii) can be present in an amount of up to 30 mole %, or up to 25 mole %, or up to 20 mole %, or up to 15 mole %, or up to 13 mole %, or up to 10 mole %, or up to 8 mole %, based on 100 mole % of all polyhydroxyl compounds (a). Suitable ranges of the polyhydroxyl compounds (a)(ii) include, in mole % based on 100 mole % of all polyhydroxyl compounds (a), 1-30, or 2-30, or 5-30, or 8-30, or 10-30, or 1-25, or 2-25, or 5-25, or 8-25, or 10-25, or 1-20, or 2-20, or 5-20, or 8-20, or 10-20, or 1-15, or 2-15, or 5-15, or 8-15, or 10-15, or 1-13, or 2-13, or 5-13, or 8-13, or 10-13, or 1-10, or 2-10, or 5-10, or 8-10, or 1-8, or 2-8, or 5-8.

The mole % of the diol (a)(i) is desirably from 70 to 100, 80 to 97, or 85 to 95, and the mole % of the polyhydroxyl compound (a)(ii) is desirably from 0 to 30, 3 to 20, or 5 to 15.

Desirably, all of the polyhydroxyl compounds (a) used to react with the polycarboxylic compounds (b) are hydrocarbons, meaning that they contain only oxygen, carbon, and hydrogen. Optionally, none of the polyhydroxyl compounds (a) contain any ester, carboxyl (—COO—), and/or anhydride groups. Optionally, none of the polyhydroxyl compounds (a) have any carbonyl groups (—CO—). Optionally, none of the polyhydroxyl compounds (a) contain any ether groups. Desirably, the polyhydroxyl compounds (a) have from 2 to 20, or 2 to 16, or 2 to 12, or 2 to 10 carbon atoms.

The polycarboxyl compounds (b) contain at least polycarboxylic acid compounds, derivatives of polycarboxylic acid compounds, the anhydrides of polycarboxylic acids, or combinations thereof. Suitable polycarboxylic acid compounds include compounds having at least two carboxylic acid groups. The polycarboxylic acid compounds are capable of forming ester linkages with polyhydroxyl compounds. For example, a polyester can be synthesized by using a polyhydroxyl compound and a dicarboxylic acid or a derivative of a dicarboxylic acid such as, for example, dimethyl ester or other dialkyl esters of the diacid, or diacid chloride or other diacid halides, or acid anhydride.

The polycarboxylic acid compounds (b) can be a combination of aromatic polycarboxylic acid compounds and either or both of aliphatic or cycloaliphatic polycarboxylic acid compounds. For example, the polycarboxylic acid compounds (b) can include aromatic polycarboxylic acid compounds and aliphatic polycarboxylic acids compounds having 2 to 22 carbon atoms; or aromatic polycarboxylic acid compounds and cycloaliphatic polycarboxylic acids compounds having 2 to 22 carbon atoms; or aromatic polycarboxylic acid compounds, aliphatic polycarboxylic acids compounds having 2 to 22 carbon atoms; and cycloaliphatic polycarboxylic acids compounds having 2 to 22 carbon atoms.

Examples of such polycarboxylic compounds (b) that form the polycarboxylic (b) residues in the curable polyester include those having two or more, desirably only two, carboxylic acid functional groups or their esters. Examples of these compounds include aliphatic dicarboxylic acids, alicyclic dicarboxylic acids, aromatic dicarboxylic acids, derivatives of each, or mixtures of two or more of these acids, or the C₁-C₄ ester derivatives thereof. Suitable dicarboxylic acids include, but are not limited to, isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, hexahydrophthalic anhydride, tetrahydrophthalic anhydride, tetrachlorophthalic anhydride, dodecanedioic acid, sebacic acid, azelaic acid, succinic anhydride, succinic acid, adipic acid, 2,6-naphthalenedicarboxylic acid, glutaric acid, diglycolic acid; 2,5-norbornanedicarboxylic acid; 1,4-naphthalenedicarboxylic acid; 2,5-naphthalenedicarboxylic acid; diphenic acid; 4,4′-oxydibenzoic acid; 4,4′-sulfonyidibenzoic acid, and mixtures thereof.

Anhydride analogs to each of the polycarboxyl compounds (b) described above can be used. This would include the anhydrides of polycarboxylic acids having at least two acyl groups bonded to the same oxygen atom. The anhydrides can be symmetrical or unsymmetrical (mixed) anhydrides. The anhydrides have at least one anhydride group, and can include two, three, four, or more anhydride groups. Specific examples of anhydrides of the dicarboxylic acids include, but are not limited to, maleic anhydride, maleic acid, fumaric acid, itaconic anhydride, itaconic acid, citraconic anhydride, citraconic acid, aconitic acid, aconitic anahydride, oxalocitraconic acid and its anhydride, mesaconic acid or its anhydride, beta-acylacrylic acid, phenyl maleic acid or its anhydride, t-butyl maleic acid or its anhydride, monomethyl fumarate, monobutyl fumarate, methyl maleic acid or its anhydride, or mixtures thereof.

Desirably, the polycarboxylic component (b) includes isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, adipic acid, 2,6-naphthalenedicarboxylic acid, 1,4-naphthalenedicarboxylic acid; 2,5-naphthalenedicarboxylic acid; hexahydrophthalic anhydride, tetrahydrophthalic anhydride, trimellitic anhydride, succinic anhydride, succinic acid, or mixtures thereof. Trimellitic acid or its anhydride is a useful compound to add in order to increase the acid number of the curable polyester if so desired.

The curable polyester of the invention has a cumulative hydroxyl number and acid number in a range of 0 to 300 mgKOH/g, or 3 to 280, or 10 to 250, or 20 to 200, or 30 to 150, or 40 to 120, or 50 to 100.

For hydroxyl functional polyester, the hydroxyl number desirably is from about 30 to about 150 mg KOH/g. The acid number of the hydroxyl functional polyester is not particularly limited. The acid number may range from 0 to about 120 mgKOH/g. The acid number may vary depending on the application. For example, the desirable acid number for waterborne coating application is about 50 to about 100 to impart sufficient water dispersibility after neutralization, whereas the desired acid number for solvent-based coating application is 0 to about 10 for better solubility and lower solution viscosity.

Desirably, the acid number of the hydroxyl functional polyester for solvent-based coating application is not more than 30, or not more than 25, or not more than 20, or not more than 15, or not more than 10, or not more than 8, or not more than 5 mgKOH/g.

Acid and hydroxyl numbers are determined by titration and are reported herein as mg KOH consumed for each gram of polyester. The acid number can be measured by ASTM D1639-90 test method. The hydroxyl numbers can be measured by the ASTM D4274-11 test method.

The glass transition temperature (Tg) of the polyester of the present invention may be from −40° C. to 120° C., from −10° C. to 100° C., from 10° C. to 80° C., from 10° C. to 60° C., from 10° C. to 50° C., from 10° C. to 45° C., from 10° C. to 40° C., from 20° C. to 80° C., from 20° C. to 60° C., from 20° C. to 50° C., from 30° C. to 80° C., from 30° C. to 70° C., from 30° C. to 60° C., from 30° C. to 50° C., or from 35° C. to 60° C. The Tg is measured on the dry polymer using standard techniques, such as differential scanning calorimetry (“DSC”), well known to persons skilled in the art. The Tg measurements of the polyesters are conducted using a “dry polymer,” that is, a polymer sample in which adventitious or absorbed water is driven off by heating to polymer to a temperature of about 200° C. and allowing the sample to return to room temperature. Typically, the polyester is dried in the DSC apparatus by conducting a first thermal scan in which the sample is heated to a temperature above the water vaporization temperature, holding the sample at that temperature until the vaporization of the water absorbed in the polymer is complete (as indicated by an a large, broad endotherm), cooling the sample to room temperature, and then conducting a second thermal scan to obtain the Tg measurement.

The number average molecular weight (Mn) of the polyester of the present invention is not limited, and may be from 1,000 to 20,000, from 1,000 to 15,000, from 1,000 to 12,500, from 1,000 to 10,000, from 1,000 to 8,000, from 1,000 to 6,000, from 1,000 to 5,000, from 1,000 to 4000, from 1,000 to 3,000, from 1,000 to 2,500, from 1,000 to 2,250, or from 1,000 to 2,000, in each case g/mole. The Mn is measured by gel permeation chromatography (GPC) using polystyrene equivalent molecular weight.

The weight average molecular weight (Mw) of the polyester can be from 1,000 to 100,000; from 1,500 to 50,000; and desirably from 2,000 to 20,000 or from 2,500 to 10,000 g/mole. The polyester may be linear or branched.

Desirably, in any of the embodiments of the invention, the (a)(i) diol includes 2,2-dimethyl-1,3-propanediol (neopentyl glycol); 1,2-cyclohexanedimethanol; 1,3-cyclohexanedimethanol; 1,4-cyclohexanedimethanol; 2-methyl-1,3-propanediol; TMCD; 2,2,4-trimethyl-1,3-pentanediol; hydroxypivalyl hydroxypivalate; 2-butyl-2-ethyl-1,3-propanediol; 1,4-butanediol; 1,6-hexanediol; or combinations thereof.

Desirably, in any of the embodiments of the invention, the (a)(ii) polyhydroxyl compound having 3 or more hydroxyl groups include 1,1,1-trimethylol propane, 1,1,1-trimethylolethane, glycerin, pentaerythritol, or combinations thereof.

Desirably, in any of the embodiments of the invention, the (b) compounds include isophthalic acid (or dimethyl isophthalate), 1,4-cyclohexanedicarboxylic acid, 1,3-cyclohexanedicarboxylic acid, adipic acid; phthalic acid; or combinations thereof.

The hydroxyl or carboxyl functional polyester can be prepared by any conventional process for the preparation of polyesters. For example, the polyester resin can be prepared by combining polyhydroxyl compounds (a) with the polycarboxyl compounds (b) in a reaction vessel under heat to form a reaction mixture comprising the polyester in a batch or continuous process and in one or more stages, optionally with the continuous removal of distillates and applied vacuum during at least part of the residence time. Polyhydroxyl compounds (a) and polycarboxyl compounds (b) are combined and reacted in at least one reactor at a temperature from 180-250° C., optionally in the presence of an acid catalyst. Desirably, a distillate is removed from the reactor.

In addition to using the method described above, carboxyl functional polyester can also be prepared by reacting a hydroxyl functional polyester with a polycarboxylic anhydride to generate the desired number of carboxyl functionalities. In this method, the hydroxyl functional polyester is first prepared at a temperature of 180 to 250° C., and then the temperature is reduced and a polycarboxylic anhydride added for further reaction at a temperature of 140 to 180° C. Suitable polycarboxylic anhydride includes trimellitic anhydride, hexahydrophthalic anhydride, maleic anhydride, and succinic anhydride. Desirable acid numbers of such carboxyl functional polyesters can be from about 30 to about 100.

The beta-ketoacetate functionally polyesters suitable for this invention include acetoacetate functional polyester, which may be prepared by reacting a polyester containing hydroxyl groups, for example, a polymer having a hydroxyl number of at least 5, preferably about 30 to 200, with an alkyl acetoacetate or diketene. Various methods for the preparation of acetoacetylated polyester coating resins have been described by Witzeman et al. in the Journal of Coatings Technology, Vol. 62, No. 789, pp. 101-112 (1990). Suitable alkyl acetoacetates for the reaction with (esterification of) a hydroxyl-containing polyester include t-butyl acetoacetate, ethyl acetoacetate, methyl acetoacetate, isobutyl acetoacetate, isopropyl acetoacetate, n-propyl acetoacetate, and n-butyl acetoacetate, t-Butyl acetoacetate is preferred. The carbamate functional polyester suitable for this invention is a polyester having the functionality below (2):

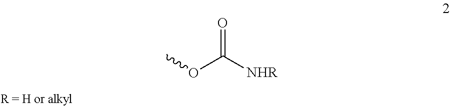

A non-limiting example for preparing such a polyester is to react a carboxyl-functional polyester with hydroxyalkyl carbamate, for example, hydroxypropyl carbamate available from Huntsman as CARBALINK® HPC. It can also be prepared by reacting a hydroxyl-functional polyester with urea or an alkyl carbamate such as, for example, methyl carbamate.

The amino functional polyester suitable for this invention can be prepared by reacting an unsaturated polyester with ammonium or a primary amine as illustrated below. The preparation of such polyesters is disclosed in Canadian Patent Application CA2111927 (A1), the content of which is incorporated in its entirety by reference.

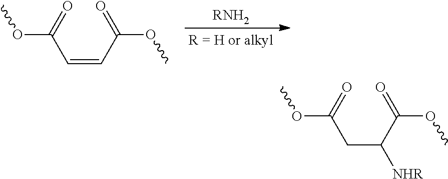

The phenol functional polyester suitable for the invention can be prepared by reacting a hydroxyl functional polyester with p-hydroxylbenzoic acid (PHBA) or its ester such as methyl 4-hydroxybenzoate (MHB). It can also be prepared by using PHBA, MHB, or 5-hydroxyisophthalic acid as one of the monomers for polycondensation reaction.

The α,β-unsaturated dicarboxylate functional polyester suitable for this invention is a polyester comprising the following structure residue (3).

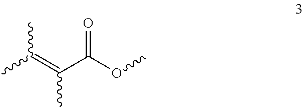

Such a polyester can be prepared by incorporating an α,β-ethylenically unsaturated carboxyl compound as a carboxylic acid component for polyester synthesis. Examples of such components include, but are not limited to, maleic anhydride, maleic acid, fumaric acid, itaconic anhydride, itaconic acid, citraconic anhydride, citraconic acid, acrylic acid, and methacrylic acid. The preferred are maleic anhydride, maleic acid, fumaric acid, itaconic anhydride, and itaconic acid.

The maleimide functional polyester suitable for this invention is a polyester having the functionality below (4):

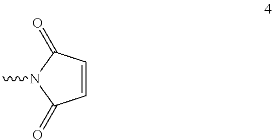

A non-limiting example for preparing such a polyester is to react a hydroxyl functional polyester (6) with a maleimide compound having carboxyl functionality (5), which in turned can be prepared by reacting 4-aminobenzoic acid with maleic anhydride. The reaction scheme is shown below:

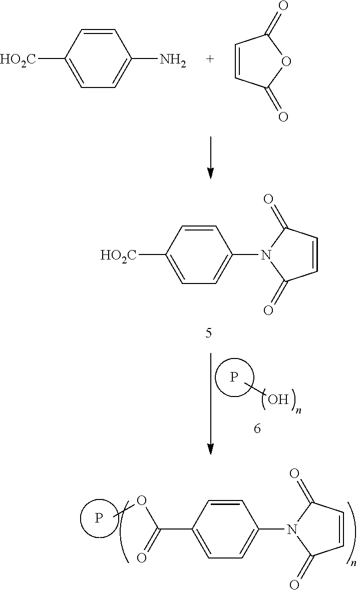

The thermosetting composition can further comprise one or more organic solvents selected from the group comprising benzene, xylene, mineral spirits, naphtha, toluene, acetone, methyl ethyl ketone, methyl n-amyl ketone, methyl isoamyl ketone, n-butyl acetate, isobutyl acetate, t-butyl acetate, n-propyl acetate, isopropyl acetate, ethyl acetate, methyl acetate, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, 2,2,4-trimethyl-1,3-pentanediol monoisobutyrate, Aromatic 100 Fluid (ExxonMobil), and Aromatic 150 Fluid (ExxonMobil). The organic solvent can be present in an amount from 30 to 85 wt. % based on the total weight of resole and polyester, (I) and (II), or from 40 to 80 wt. %, or from 50 to 75 wt. %, or from 55 to 70 wt. %, or 60 to 65 wt. %.

The phenolic hydroxyl group of the resole of the invention is acidic and thus can be neutralized with a base for waterborne applications. Thus, this invention further provides a resole aqueous dispersion comprising the resole phenolic resin of the present invention, a neutralizing agent, and water. The neutralizing agent may be an amine such as ammonium hydroxide, triethylamine, N,N-dimethylethanolamine, 2-amino-2-methyl-1-propanol, and the like, or an inorganic base such as sodium hydroxide, potassium hydroxide, and the like.

In a further embodiment, this invention provides a waterborne thermosetting composition comprising said resole aqueous dispersion and a waterborne curable polyester which has one or more functionalities selected from the groups comprising hydroxyl, carboxyl, α,β-unsaturated dicarboxylate, beta-ketoacetate, carbamate, phenol, amino, and maleimide groups. Said waterborne curable polyester may be amine neutralized polyester or polyester containing the residues of one or more hydrophilic monomers such as 5-sodiosulfoisophthalic acid, polyetheylene glycol, or Ymer™ N120 (available from Perstorp) to provide water dispersibility.

The waterborne thermosetting composition of this disclosure may further comprise an organic co-solvent. Suitable co-solvents include ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diacetone alcohol, and other water-miscible solvents.

Desirably, the polyesters used for waterborne thermosetting compositions comprise TMCD in the polyester compositions. It has been found that TMCD based polyesters exhibit superior water dispersibility over polyesters based on other diols such as NPG and CHDM.

The thermosetting composition of the present invention can further comprise an acid or base catalyst in an amount ranging from 0.1 to 10 weight %, or 0.1 to 9 weight %, or 0.1 to 8 weight %, or 0.1 to 7 weight %, or 0.1 to 6 weight %, or 0.1 to 5 weight %, or 0.1 to 4 weight %, or 0.1 to 3 weight %, or 0.1 to 2 weight %, or 0.1 to 1.5 weight %, or 0.1 to 1.2 weight %, or 0.1 to 1 weight %, or 0.1 to 0.9 weight %, or 0.1 to 0.8 weight %, or 0.1 to 0.7 weight %, or 0.1 to 0.6 weight %, or 0.1 to 0.5 weight %, or 0.2 to 10 weight %, or 0.2 to 9 weight %, or 0.2 to 8 weight %, or 0.2 to 7 weight %, or 0.2 to 6 weight %, or 0.2 to 5 weight %, or 0.2 to 4 weight %, or 0.2 to 3 weight %, or 0.2 to 2 weight %, or 0.2 to 1.5 weight %, or 0.2 to 1.2 weight %, or 0.2 to 1 weight %, or 0.2 to 0.9 weight %, or 0.2 to 0.8 weight %, or 0.2 to 0.7 weight %, or 0.2 to 0.6 weight %, or 0.2 to 0.5 weight %, or 0.3 to 10 weight %, or 0.3 to 9 weight %, or 0.3 to 8 weight %, or 0.3 to 7 weight %, or 0.3 to 6 weight %, or 0.3 to 5 weight %, or 0.3 to 4 weight %, or 0.3 to 3 weight %, or 0.3 to 2 weight %, or 0.3 to 1.5 weight %, or 0.3 to 1.2 weight %, or 0.3 to 1 weight %, or 0.3 to 0.9 weight %, or 0.3 to 0.8 weight %, or 0.3 to 0.7 weight %, or 0.3 to 0.6 weight %, or 0.4 to 10 weight %, or 0.4 to 9 weight %, or 0.4 to 8 weight %, or 0.4 to 7 weight %, or 0.4 to 6 weight %, or 0.4 to 5 weight %, or 0.4 to 4 weight %, or 0.4 to 3 weight %, or 0.4 to 2 weight %, or 0.4 to 1.5 weight %, or 0.4 to 1.2 weight %, or 0.4 to 1 weight %, or 0.4 to 0.9 weight %, or 0.4 to 0.8 weight %, or 0.4 to 0.7 weight %, or 0.5 to 10 weight %, or 0.5 to 9 weight %, or 0.5 to 8 weight %, or 0.5 to 7 weight %, or 0.5 to 6 weight %, or 0.5 to 5 weight %, or 0.5 to 4 weight %, or 0.5 to 3 weight %, or 0.5 to 2 weight %, or 0.5 to 1.5 weight %, or 0.5 to 1.2 weight %, or 0.5 to 1 weight %, or 0.5 to 0.9 weight %, or 0.5 to 0.8 weight %, or 0.6 to 10 weight %, or 0.6 to 9 weight %, or 0.6 to 8 weight %, or 0.6 to 7 weight %, or 0.6 to 6 weight %, or 0.6 to 5 weight %, or 0.6 to 4 weight %, or 0.6 to 3 weight %, or 0.6 to 2 weight %, or 0.6 to 1.5 weight %, or 0.6 to 1.2 weight %, or 0.6 to 1 weight %, or 0.6 to 0.9 weight %, or 0.6 to 0.8 weight %, or 0.7 to 10 weight %, or 0.7 to 9 weight %, or 0.7 to 8 weight %, or 0.7 to 7 weight %, or 0.7 to 6 weight %, or 0.7 to 5 weight %, or 0.7 to 4 weight %, or 0.7 to 3 weight %, or 0.7 to 2 weight %, or 0.7 to 1.5 weight %, or 0.7 to 1.2 weight %, or 0.7 to 1 weight %, or 0.8 to 10 weight %, or 0.8 to 9 weight %, or 0.8 to 8 weight %, or 0.8 to 7 weight %, or 0.8 to 6 weight %, or 0.8 to 5 weight %, or 0.8 to 4 weight %, or 0.8 to 3 weight %, or 0.8 to 2 weight %, or 0.8 to 1.5 weight %, or 0.8 to 1.2 weight %, or 0.9 to 10 weight %, or 0.9 to 9 weight %, or 0.9 to 8 weight %, or 0.9 to 7 weight %, or 0.9 to 6 weight %, or 0.9 to 5 weight %, or 0.9 to 4 weight %, or 0.9 to 3 weight %, or 0.9 to 2 weight %, or 0.9 to 1.5 weight %, or 0.9 to 1.2 weight %, or 0.9 to 1.0 weight %, or 1.0 to 10 weight %, or 1.0 to 9 weight %, or 1.0 to 8 weight %, or 1.0 to 7 weight %, or 1.0 to 6 weight %, or 1.0 to 5 weight %, or 1.0 to 4 weight %, or 1.0 to 3 weight %, or 1.0 to 2 weight %, or 1.0 to 1.5 weight %, or 1.0 to 1.2 weight %, or 1.0 to 1.0 weight %, based on the total weight of polyester and phenolic resin. Examples of acid catalyst include protonic acids such as p-toluenesulfonic acid, dinonylnaphthalene disulfonic acid, dodecylbenzenesulfonic acid, phosphoric acid, and the like. One example of the commercial phosphoric acid catalyst is CYCAT XK406N (9% active) (available from Allnex). In one embodiment, when the acid catalyst is sulfonic acid type as listed above, the desirable amount can be from about 0.3 to about 0.7 weight %, or from about 0.4 to about 0.6 weight %, or about 0.5 weight %, based on the total weight of the resins (polyester and phenolic resin). In one embodiment, when the acid catalyst is phosphoric acid, the desirable amount can be from about 0.8 to about 1.2, or from about 0.9 to about 1, or about 1 weight %, based on the total weight of the resins (polyester and phenolic resin). The acid catalyst may also be Lewis acid or amine-blocked acid catalyst. Examples of base catalyst include amine such as ammonium hydroxide, triethylamine, N,N-dimethylethanolamine, and the like, and inorganic base such as sodium hydroxide, potassium hydroxide, and the like.

The thermosetting composition of this disclosure can further comprise a conventional crosslinker known in the art, such as, for example, aminoplast, isocyanate, and epoxy crosslinkers.

In one embodiment, the thermosetting composition of this disclosure can be a coating composition.

In addition to coating applications, the thermosetting composition can also be used for other applications, such as adhesive, plastic molding, rubber compounding, where forming a polymeric network is desirable.

The thermosetting composition of this invention can further comprise natural rubber, synthetic rubber, or a combination thereof.

As a further aspect of the present disclosure, there is provided a coating composition as described above, further comprising one or more leveling, rheology, and flow control agents such as silicones, fluorocarbons or cellulosics; flatting agents; pigment wetting and dispersing agents; surfactants; ultraviolet (UV) absorbers; UV light stabilizers; tinting pigments; defoaming and antifoaming agents; anti-settling, anti-sag and bodying agents; anti-skinning agents; anti-flooding and anti-floating agents; fungicides and mildewicides; corrosion inhibitors; thickening agents; and/or coalescing agents.

Specific examples of such additives can be found in Raw Materials Index, published by the National Paint & Coatings Association, 1500 Rhode Island Avenue, N.W., Washington, D.C. 20005.

After formulation, the coating composition can be applied to a substrate or article. Thus, a further aspect of the present disclosure is a shaped or formed article that has been coated with the coating compositions of the present disclosure. The substrate can be any common substrate such as paper; polymer films such as polyethylene or polypropylene; wood; metals such as aluminum, tin, steel or galvanized sheeting; glass; urethane elastomers; primed (painted) substrates; and the like. The coating composition can be coated onto a substrate using techniques known in the art, for example, by spraying, draw-down, roll-coating, etc., to form a dried coating having a thickness of about 0.1 to about 4 mils (1 mil=25 μm), or 0.5 to 3, or 0.5 to 2, or 0.5 to 1 mils on the substrate. The coating can be cured by heating to a temperature of about 150° C. to about 230° C., or desirably from 160° C. to 200° C., for a time period that typically ranges about 10 seconds to about 90 minutes and allowed to cool.

The invention is further illustrated by the following examples. The following examples are given to illustrate the invention and to enable any person skilled in the art to make and use the invention. It should be understood, however, that the invention is not to be limited to the specific conditions or details described in these examples. The patentable scope of the invention is defined by the claims, and may include other examples that occur to those skilled in the art. By the abbreviation (wt. %), the term weight percent is intended throughout the present disclosure.

### EXAMPLES

### Test Methods

### MEK Double Rubs:

MEK double rub test was carried out according to ASTM method D4752 by using an automatic rub machine equipped with a hemispherical hammer having a weight of 720 gram. A 16-fold cheesecloth was wrapped around the hammer end and soaked with methyl ethyl ketone (MEK). The coated test panel was placed underneath the wrapped hammer and rubbed back and forth until the main body of the film was first exposing the metal, discounting the effect on the end of the rubbed film. One back and forth movement is counted as one double rub.

### Wedge Bend Test:

Wedge bend test was carried out using Gardner Impact tester PF-1125 equipped with a steel rod for bending. A 10 cm×3.8 cm coated panel was cut and bent in half over the 3 mm rod with the coating on the outside of the bend. The folded panel was then inserted in the wedge mandrel. A metal weight was raised to the 40 in-lb mark and dropped; the cylindrical fold in the panel was squeezed into a conical shape. The edge of the coated panel as rubbed with a solution of copper sulfate (mixture of deionized water (69 g), copper sulfate (40 g), HCl (20 g), and Dowfax 2A1 (2 g, available from Dow). Dark spots appeared where the coating had been cracked. The length of the failure was then measured and expressed as % failure over the length of the panel.

### Water Retort Test:

A 10 cm×3.8 cm coated panel was immersed halfway in deionized water in a 250 mL jar, which was then covered by a cap. The jar was placed into an electronic table-top autoclave (Tuttnauer Model 2340, available from Tuttnauer USA) at 121° C. for one hour. After that, the autoclave was allowed to depressurize and the jar removed. The panel was then removed from the jar and patted dried with a paper towel. The 20° gloss of the coating was measured by using a gloss meter before and after the retort test and the difference recorded.

### Acid Retort Test:

The procedure for the water retort test was followed by replacing the deionized water with a solution of lactic acid (1%), acetic acid (1%), and NaCl (1%) in deionized water.

### Example 1

### Synthesis of Etherified Resole Phenolic Resin Based on m-Cresol (HCHO/m-Cresol=1.8 by Mole; One Hour Reaction Time) (Resole 1)

To a round-bottom flask equipped with a water-jacketed condenser were added m-cresol (48.7 g, 0.45 mole) and formaldehyde (37 wt. % solution in water) (65.4 g, 0.81 mole). The pH of the mixture was adjusted to about 9.5-10 by dropwise addition of NaOH solution. The resulting homogeneous mixture was stirred and allowed to react at 60° C. for one hour under nitrogen. After the reaction, the flask was placed in an ice/water bath, and the pH of the resulting mixture was adjusted to about 7.2-7.5 by dropwise addition of diluted HCl aqueous solution. The volatiles of the mixture were subsequently removed using a rotary evaporator under reduced pressure to yield a viscous crude resin. n-Butanol (84 mL) and toluene (7 mL) were then added to dissolve the resin at 40° C. After cooling, the solution was filtered by suction filtration to remove the insoluble solid particles. The pH of the resulting resole resin solution was adjusted to about 5.6 by gradual addition of phosphoric acid in ethanol for etherification reaction as described below:

### Etherification

To a round-bottom flask equipped with a Dean-Stark adaptor and a water-jacketed condenser was added the above resole resin solution. The mixture was stirred and allowed to reflux at 120° C. for 5 hours. A total of 8 mL of water was collected in the Dean-Stark adaptor. Upon cooling, the resulting mixture was filtered to remove solid impurities, and the solvent was subsequently removed using a rotary evaporator under reduced pressure to yield a viscous yellow resole phenolic resin. The yield was 76 g.

### Example 2

### Synthesis of Unetherified Resole Phenolic Resin Based on m-Cresol (HCHO/m-Cresol=1.8 by Mole; Four Hours Reaction Time) (Resole 2)

To a round-bottom flask equipped with a water-jacketed condenser were added m-cresol (48.7 g, 0.45 mole) and formaldehyde (37 wt. % solution in water) (65.4 g, 0.81 mole). The pH of the mixture was adjusted to about 9.5-10 by dropwise addition of NaOH solution. The resulting homogeneous mixture was stirred and allowed to react at 60° C. for 4 hours under nitrogen. After the reaction, the flask was placed in an ice/water bath, and the pH of the resulting mixture was adjusted to about 7.2-7.5 by dropwise addition of diluted HCl aqueous solution. The volatiles of the mixture were subsequently removed using a rotary evaporator under reduced pressure to yield a viscous crude resin. n-Butanol (150 mL) was then added to dissolve the resin at 40° C., which was filtered by suction filtration to remove the insoluble solid particles to afford a resole phenolic resin solution. The solvent, n-butanol, was subsequently removed using a rotary evaporator under reduced pressure to yield a viscous yellow-red unetherified resole phenolic resin.

### Example 3

### Synthesis of Etherified (Butylated) Resole Phenolic Resin Based on m-Cresol (Resole 3)

An unetherified resole resin was first synthesized according to Example 2. To this resole resin (74 g) were added n-butanol (84 mL) and toluene (7 mL) to form a solution. The pH of the solution was adjusted to about 6 by gradual addition of phosphoric acid in ethanol. The resole resin solution thus prepared was added to a round-bottom flask equipped with a Dean-Stark adaptor and a water-jacketed condenser. The solution was stirred and allowed to reflux at 120° C. for 4.5 hours. A total of 6 mL of water was collected in the Dean-Stark adaptor. Upon cooling, the resulting mixture was filtered to remove solid impurities, and the solvent was subsequently removed using a rotary evaporator under reduced pressure to yield a viscous yellow-red resole phenolic resin.

### Example 4

### Synthesis of Hydroxyl Functional Polyester (PE-1)

A 2-L kettle with a four-neck lid was equipped with a mechanical stirrer, a thermocouple, a heated partial condenser (107° C.), a Dean-Stark trap, and a chilled condenser (15° C.). The kettle was charged with 2,2,4,4-tetramethyl-1,3-cyclobutanediol (TMCD) (351.1 g), 2-methyl-1,3-propanediol (MPDiol) (219.4 g), trimethylolpropane (TMP) (15.3 g); isophthalic acid (IPA) (697.8 g); and the acid catalyst, Fascat-4100 (Arkema Inc.) (1.93 g). The reaction was allowed to react under a nitrogen blanket. The temperature was ramped up from room temperature to 150° C. over 90 minutes. Once reaching the meltdown temperature of 150° C., the temperature was increased from 150 to 230° C. over 3 hours. When the maximum temperature of 230° C. was reached, the reaction was allowed to continue until the theoretical distillate (about 150 g) was collected. The resin was then sampled for acid number analysis with a target of <5 mgKOH/g. After achieving an acid number of 2.6, the resin was allowed to cool to 190° C. before being poured into aluminum pans. The resin was cooled and a solid product collected.

Using the same method as above, PE-2 and PE-3 were synthesized. The relative amounts of the reactants and the results are reported in Tables 1 and 2, wherein Mn is number average molecular weight and Mw is weight average molecular weight.

TABLE 1
Synthesized Hydroxyl Functional Polyesters

| | Resin Composition as Charged | | | | Total eq. |
|---|---|---|---|---|---|
| | Equivalent (eq.) Ratio Based | | | Eq. Ratio Based | of OH/ |
| | on Total Alcohols (%) | | | on Total Diacids (%) | total eq. |
| | TMCD | MPDiol | TMP | IPA | of COOH |
| PE-1 | 48.3 | 48.3 | 3.4 | 100 | 1.2 |
| PE-2 | 46.7 | 46.7 | 6.6 | 100 | 1.2 |
| PE-3 | 45.0 | 45.0 | 10.0 | 100 | 1.2 |

TABLE 2
Resin Properties of Synthesized Hydroxyl Functional Polyesters

| | | | | Acid | OH |
|---|---|---|---|---|---|
| | | | | Number | Number |
| Polyester | Tg, ° C. | Mn | Mw | Analyzed | Analyzed |
| PE-1 | 56.1 | 2605 | 6015 | 2.6 | 60.5 |
| PE-2 | 61.4 | 2962 | 8750 | 1.3 | 57.4 |
| PE-3 | 60.8 | 2875 | 8391 | 2.5 | 63.3 |

### Example 5

### Preparation of Solvent-Based Formulations Using m-Cresol Based Resole Phenolic Resin

As listed in Table 3, solvent-based formulations were prepared by using the polyesters, PE-1, PE-2, and PE-3, and the resole phenolic resins, Resole 1, Resole 2, and Resole 3. Polyester solutions (35% solids) were first prepared by dissolving the polyester in methyl amyl ketone (MAK). Formulations were then prepared by mixing respectively the polyester solution with a resole phenolic resin (100%) in the presence of an acid catalyst, p-toluenesulfonic acid (pTSA).

TABLE 3
Compositions of Various Formulations

| | Polyester | Resole | pTSA | | |
|---|---|---|---|---|---|
| | (35% in | Resin | (5% in | | |
| Formu- | MAK); | (100%); | isopropanol); | Resin | Catalyst |
| lation | grams | grams | grams | Ratio | Ratio |
| 1 | 10 | 1.5 | 0.5 | 70/30 | 0.5 phr |
| | (PE-1) | Resole 1 | | | (parts per |
| | | | | | hundred |
| | | | | | of resin) |
| 2 | 10 | 1.5 | 0.5 | 70/30 | 0.5 phr |
| | (PE-2) | Resole 1 | | | |
| 3 | 10 | 1.5 | 0.5 | 70/30 | 0.5 phr |
| | (PE-3) | Resole 1 | | | |
| 4 | 10 | 1.5 | 0.5 | 70/30 | 0.5 phr |
| | (PE-1) | Resole 2 | | | |
| 5 | 10 | 1.5 | 0.5 | 70/30 | 0.5 phr |
| | (PE-2) | Resole 2 | | | |
| 6 | 10 | 1.5 | 0.5 | 70/30 | 0.5 phr |
| | (PE-3) | Resole 2 | | | |
| 7 | 10 | 1.5 | 0.5 | 70/30 | 0.5 phr |
| | (PE-1) | Resole 3 | | | |
| 8 | 10 | 1.5 | 0.5 | 70/30 | 0.5 phr |
| | (PE-2) | Resole 3 | | | |
| 9 | 10 | 1.5 | 0.5 | 70/30 | 0.5 phr |
| | (PE-3) | Resole 3 | | | |

### Example 6

### Evaluation of Cured Films by MEK Double Rub Test

Formulations 1-9 prepared in Example 5 were drawn down respectively on electrolytic tin test panels (10 cm×30 cm) using a draw-down bar and subsequently baked in an oven at 205° C. for 10 minutes. The thickness of the coating films was about 10 μm. The degree of crosslinking of the cured films was determined by their solvent resistance using MEK Double Rub Method (ASTM D4752). In the test, the rubbing was stopped when the main body of the film was first exposing the metal, discounting the effect on the end of the rubbed film. The results are collected in Table 4. Typically a result of >30 is considered acceptable and >100 is preferred.

TABLE 4
MEK Double Rub Test of the Cured
Films from Various Formulations

| | Formulation | | | | | | | | |
|---|---|---|---|---|---|---|---|---|---|
| | 1 | 2 | 3 | 4 | 5 | 6 | 7 | 8 | 9 |
| MEK | 30 | 70 | 60 | 100 | 500 | 450 | 125 | 350 | 350 |
| double | | | | | | | | | |
| rubs | | | | | | | | | |

### Example 7

### Synthesis of Polyester with Hydroxyl and Carboxyl Functionalities (PE-4)

A 500 mL, three-neck, round-bottom flask was equipped with a mechanical stirrer, a heated partial condenser, a Dean-Stark trap, and a water condenser. To the flask were charged 2,2,4,4-tetramethyl-13-cyclobutanediol (TMCD) (70.0 g); trimethylolpropane (TMP) (6.66 g); 1,4-cyclohexanedicarboxylic acid (CHDA) (34.4 g), isophthalic acid (IPA) (33.2 g), and the acid catalyst, Fascat-4100 (Arkema Inc.) (0.22 g). The reaction was allowed to react under nitrogen at 180° C. for 25 min., at 200° C. for 60 min., at 220° C. for 125 min., and at 230° C. for about 2.5 hours to yield a clear, viscous mixture. A total of 12 mL of distillate was collected in the Dean-Stark trap. The reaction mixture was then allowed to cool to 150° C., followed by the addition of trimellitic anhydride (TMA) (14.06 g). After the addition of TMA, the temperature was increased to 170° C. and the mixture allowed to react for about 1.5 hours. The resulting mixture was allowed to cool to room temperature and subsequently placed in dry ice to chill for ease to break and collect the solid product (133 g). The polyester was analyzed to have the properties: Tg, 89.6° C.; Mn 1659, Mw 5470; acid number 58; and hydroxyl number 97.

### Example 8

### Synthesis of Resole Phenolic Resin Based on m-Cresol (HCHO/m-Cresol=2.0 by Mole; Solvent Process)

To a round-bottom flask equipped with a water-jacketed condenser were added m-cresol (30.0 g), paraformaldehyde (16.7 g), triethylamine (5.6 g), and toluene (200 mL). The reaction mixture was stirred and allowed to react at 60° C. for 5 hours. After the reaction, the resulting mixture was cooled to room temperature, which was separated into two layers—an oily resin layer and a toluene layer at the top. The resin layer was collected and washed repeatedly with fresh toluene using a rotary evaporator. The resulting viscous resin was dissolved in methyl ethyl ketone and subsequently filtered to remove the insoluble impurities. The solvent was removed under reduced pressure, and the resulting resin was mixed with toluene to further remove the volatiles using the rotary evaporator. A highly viscous, brown-yellow resin was obtained. The yield was 25 g.

### Comparative Example 1

### Synthesis of Resole Phenolic Resin Based on o-Cresol (o-Cresol/HCHO)

To a round-bottom flask equipped with a water-jacketed condenser were added o-cresol (43.2 g), aqueous formaldehyde solution (37 wt. %, 162 g), and NaOH (20 wt. % in water, 15 mL). The reaction mixture was stirred and allowed to react at 60° C. for three days. After the reaction, the resulting mixture was cooled to room temperature, which was separated into two layers—an oily resin layer and a water layer at the top. The resin layer was collected and subsequently dissolved in ethanol. To the resin solution was added dilute aqueous HCl solution. The resin layer was collected and washed repeatedly with ethanol using a rotary evaporator. The resulting resin solid was collected and dried under vacuum at 40-45° C. to yield a yellow powdery product. The yield was 50 g.

### Comparative Example 2

### Synthesis of Resole Phenolic Resin Based on p-Cresol (p-Cresol/HCHO)

To a round-bottom flask equipped with a water-jacketed condenser were added p-cresol (43.2 g), aqueous formaldehyde solution (37 wt. %, 162 g), and NaOH (20 wt. % in water, 15 mL). The reaction mixture was stirred and allowed to react at 60° C. for three days. After the reaction, the resulting mixture was cooled to room temperature and aqueous HCl solution added to yield a precipitate. The resulting resin solid was collected, washed repeated with water, and dried under vacuum at 40-45° C. to yield a yellow powdery product. The yield was 45 g.

### Example 9

### Preparation of Solvent-Based Formulations Using Various Cresol-Based Resole Phenolic Resins

As listed in Table 5, solvent-based formulations were prepared by using polyester, PE-4, and various cresol based phenolic resins, m-Cresol/HCHO, o-Cresol/HCHO, and p-Cresol/HCHO, prepared in Example 8 and Comparative Examples 1 and 2. Polyester solution (35% solids) was first prepared by dissolving the polyester (PE-4) in methyl amyl ketone (MAK). Three formulations were then prepared by mixing respectively the polyester solution with a phenolic resin (m-Cresol/HCHO, o-Cresol/HCHO, and p-Cresol/HCHO) in the presence of an acid catalyst, p-toluenesulfonic acid (pTSA).

TABLE 5
Compositions of Various Formulations

| | Polyester | Phenolic | pTSA | | |
|---|---|---|---|---|---|
| | (35% in | Resin | (5% in | | |
| Formu- | MAK); | Solution; | isopropanol); | Resin | Catalyst |
| lation | grams | grams | grams | Ratio | Ratio |
| 10 | 10 | 2.14 | 0.5 | 70/30 | 0.5 phr |
| | (PE-4) | m-Cresol/HCHO | | | (parts per |
| | | (70% in MAK) | | | hundred |
| | | | | | of resin) |
| 11 | 10 | 3 | 0.5 | 70/30 | 0.5 phr |
| | (PE-4) | o-Cresol/HCHO | | | |
| | | (50% in MAK) | | | |
| 12 | 10 | 3 | 0.5 | 70/30 | 0.5 phr |
| | (PE-4) | p-Cresol/HCHO | | | |
| | | (50% in | | | |
| | | cyclopentanone) | | | |

### Example 10

### Evaluation of Cured Films by MEK Double Rub Test

Formulations 10-12 prepared in Example 9 were drawn down respectively on cold-rolled steel test panels (ACT 3x9x032 from Advanced Coating Technologies) using a draw-down bar and subsequently baked in an oven at 205° C. for 10 minutes. The thickness of the coating films was about 20 to 25 μm. The degree of crosslinking of the cured films was determined by their solvent resistance using MEK Double Rub Method (ASTM D4752). The results are collected in Table 6.

TABLE 6
MEK Double Rub Test of the Cured
Films from Various Formulations

| Formulation | 10 | 11 | 12 |
|---|---|---|---|
| MEK double rubs | 300 | <20 | <20 |

### Example 11

### Preparation of Aqueous Dispersions of Polyester

A Parr reactor was used for the preparation of the resin dispersion. Polyester resin, PE-4, was first ground to about 6 mm pellets. The resin pellets (42.0 g) was then placed in the reaction vessel along with distilled water (78.0 g) and ammonia aqueous solution (30%, 2.46 g) for neutralization. The amount of ammonia added for neutralization (100%) is calculated according to the measured acid number of the resin. The Parr reactor was then assembled and heated first to 95° C. and then to 110° C. The stirring was allowed to continue at 110° C. for 45 min. and subsequently allowed to cool to 50° C. The resulting dispersion (35% solids) was filtered with a standard paint filter and collected. Particle size (MV) of the dispersion was determined to be 14 nm using Nanotrac (Microtrac Inc.). The particle size, MV, represents the mean diameter in nanometer (nm) of the volume distribution.

### Example 12

### Preparation of Waterborne Formulation Using Neutralized Resole Phenolic Resin

An aqueous dispersion was prepared by mixing the phenolic resin, m-cresol/HCHO (Example 8) (3 g) sequentially with ethylene glycol monobutyl ether (EB) (1.3 g), N,N-dimethylethanolamine (DMEA) (0.7 g), and water (1.5 g) to yield a clear resole dispersion (46% solids). A waterborne formulation was then prepared by mixing the resole dispersion (0.98 g), the aqueous polyester dispersion (Example 11) (35%, 3 g), and the pTSA catalyst (5% in isopropanol, 0.15 g).

### Example 13

### Evaluation of Cured Films by MEK Double Rub Test

The formulation prepared in Example 12 was drawn down on cold-rolled steel test panels (ACT 3x9x032 from Advanced Coating Technologies) using a draw-down bar and subsequently baked in an oven at 205° C. for 10 minutes. The thickness of the coating films was about 20 to 25 μm. The cured film was determined to have 50 MEK double rubs,

### Example 14

### Synthesis of Etherified Resole Phenolic Resin Based on m-Cresol (HCHO/m-Cresol=2.5 by Mole) (Resole 4)

To a round-bottom flask equipped with a water-jacketed condenser were added m-cresol (48.7 g, 0.45 mole) and formaldehyde (37 wt. % in water) (92 g, 1.125 mole). The pH of the mixture was adjusted to 9.78 by dropwise addition of NaOH solution (40 wt. % in water). The resulting homogenous mixture was then placed in 60° C. bath, and stirred at 60° C. under inert atmosphere for 4 hours. After cooling to 0° C., the pH of the mixture was adjusted to about 7 by addition of dilute HCl and water. The upper phase was decanted; the isolated bottom layer was washed with water several times. The crude product was dissolved in 300 mL butanol, and the solvent was removed using rotary evaporator under reduced pressure.

The crude resin was dissolved in butanol, and the solution was diluted with butanol until the total volume of the solution reach approximately 500 mL. Toluene (50 mL) was subsequently added. The pH of the mixture was adjusted to 5.5 by careful addition of phosphoric acid in ethanol (prepared by approximately 1:1 volume ratio of phosphoric acid and ethanol). To a round-bottom flask equipped with a Dean-Stark adaptor and a water-jacketed condenser was added the above resole resin solution. The mixture was then allowed to reflux (at 130° C. oil bath) for 2 hours. After cooling down, the mixture was subjected to rotary evaporation under reduced pressure to remove most of the solvent. After suction filtration, the mixture was concentrated using rotary evaporator under reduced pressure to give 92 g of the final resin.

### Comparative Example 3

### Synthesis of Etherified Resole Phenolic Resin Based on m-Cresol (HCHO/m-Cresol=1.3 by Mole) (Resole 5)

To a round-bottom flask equipped with a water-jacketed condenser were added m-Cresol (48.7 g, 0.45 mole) and formaldehyde (37 wt. % in water) (47.5 g, 0.585 mole). The pH was adjusted to about 9.8 by dropwise addition of NaOH solution (40 wt. % in water). The resulting homogenous mixture was then placed in 60° C. bath, and stirred at 60° C. under inert atmosphere for 4 hours. After cooling to 0° C., the pH of the mixture was adjusted to 7.35 by dropwise addition of dilute HCl (the dilute HCl was prepared by approximately 1:19 volume ratio of concentrated HCl and water). After removal of the solvent using rotary evaporator under reduced pressure, approximately 150 mL butanol was added. The mixture was swirled until the resin dissolved, and then the solvent was removed using rotary evaporator under reduced pressure.

Butanol (200 mL) was added to dissolve the crude product, and the pH of the mixture was adjusted to around 5.5 by careful addition of phosphoric acid in ethanol (prepared by approximately 1:1 volume ratio of phosphoric acid and ethanol). Toluene (20 mL) was then added. To a round-bottom flask equipped with a Dean-Stark adaptor and a water-jacketed condenser was added the above resole resin solution. The mixture was then allowed to reflux (at 130° C. oil bath) for 2 hours. After cooling down, the mixture was subjected to rotary evaporation under reduced pressure to remove the solvent. Butanol (150 mL) was added to dissolve the mixture. After suction filtration, the mixture was concentrated using rotary evaporator under reduced pressure to give 82 g of the final resin.

### Example 15

### Synthesis of Etherified Resole Phenolic Resin Based on m-Cresol (HCHO/m-Cresol® 1.78 by Mole) (Resole 6)

To a round-bottom flask equipped with a water-jacketed condenser were added m-cresol (48.7 g, 0.45 mole) and formaldehyde (37 wt. % in water) (65.4 g, 0.80 mole). The pH was adjusted to about 9.8 by dropwise addition of NaOH solution. The resulting homogenous mixture was then placed in 60° C. bath, and stirred at 60° C. under inert atmosphere for 2.5 hours. After cooling to 0° C., the pH of the mixture was adjusted to 7.35 by dropwise addition of dilute HCl. After removal of the solvent using rotary evaporator under reduced pressure, approximately 150 mL butanol was added. The mixture was swirled until the resin dissolved, and then the solvent was removed using rotary evaporator under reduced pressure.

Butanol (100 mL) was added to dissolve the crude product, and 10 mL toluene was added. After suction filtration, another 50 mL butanol was added. The pH of the mixture was adjusted to around 5.5 by careful addition of phosphoric acid in ethanol. To a round-bottom flask equipped with a Dean-Stark adaptor and a water-jacketed condenser was added the above resole resin solution. The mixture was then allowed to reflux (at 130° C. oil bath) for 4 hours. After cooling down, the mixture was subjected to rotary evaporation under reduced pressure to remove the solvent. Butanol (150 mL) was added to dissolve the mixture. After suction filtration, the mixture was concentrated using rotary evaporator under reduced pressure to give 100 g of the final resin.

### Example 16

### Synthesis of Etherified Resole Phenolic Resin Based on m-Cresol (HCHO/m-Cresol=1.5 by Mole) (Resole 7)

To a round-bottom flask equipped with a water-jacketed condenser were added m-cresol (48.7 g, 0.45 mole) and formaldehyde (37 wt. % in water) (54.8 g, 0.68 mole). The pH was adjusted to about 9.8 by dropwise addition of NaOH solution. The resulting homogenous mixture was then placed in 60° C. bath, and stirred at 60° C. under inert atmosphere for 4 hours. After cooling to 0° C., the pH of the mixture was adjusted to 7.3 by dropwise addition of dilute HCl. After removal of the solvent using rotary evaporator under reduced pressure, approximately 150 mL butanol was added. The mixture was swirled until the resin dissolved, and then the solvent was removed using rotary evaporator under reduced pressure.

Butanol (200 mL) was added to dissolve the crude product, and the pH of the mixture was adjusted to around 5.5 by careful addition of phosphoric acid in ethanol. Toluene (20 mL) was subsequently added. To a round-bottom flask equipped with a Dean-Stark adaptor and a water-jacketed condenser was added the above resole resin solution. The mixture was then allowed to reflux (130° C. bath) for 2 hours. After cooling down, the mixture was subjected to rotary evaporation under reduced pressure to remove the solvent. Butanol (150 mL) was added to dissolve the mixture. After suction filtration, the mixture was concentrated using rotary evaporator under reduced pressure to give the final resin.

### Example 17

### Synthesis of Hydroxyl Functional Polyester (PE-4)

A 2-L kettle with a four-neck lid was equipped with a mechanical stirrer, a thermocouple, a heated partial condenser (107° C.), a Dean-Stark trap, and a chilled condenser (15° C.). The kettle was charged with 2,2,4,4-tetramethyl-1,3-cyclobutanediol (TMCD) (325.3 g), 2-methyl-1,3-propanediol (MPDiol) (203.3 g), trimethylolpropane (TMP) (28.52 g); isophthalic acid (IPA) (697.8 g); and the acid catalyst, Fascat-4100 (Arkema Inc.) (1.88 g). The reaction was allowed to react under a nitrogen blanket. The temperature was ramped up from room temperature to 150° C. over 90 minutes. Once reaching the meltdown temperature of 150° C., the temperature was increased from 150 to 230° C. over 3 hours. When the maximum temperature of 230° C. was reached, the reaction was allowed to continue until the theoretical distillate (about 150 g) was collected. The resin was then sampled for acid number analysis with a target of <5 mgKOH/g. After achieving an acid number of 6.7, the resin was allowed to cool to 190° C. before being poured into aluminum pans. The resin was cooled and a solid product collected.

Using the same method as above, PE-5 and PE-6 were synthesized. The relative amounts of the reactants and the results are reported in Tables 7 and 8, wherein Mn is number average molecular weight and Mw is weight average molecular weight.

TABLE 7
Synthesized Hydroxyl Functional Polyesters

| | Resin Composition as Charged | | | | Total eq. |
|---|---|---|---|---|---|
| | Equivalent (eq.) Ratio Based | | | Eq. Ratio Based | of OH/ |
| | on Total Alcohols (%) | | | on Total Diacids (%) | total eq. |
| | TMCD | MPDiol | TMP | IPA | of COOH |
| PE-4 | 46.7 | 46.7 | 6.6 | 100 | 1.15 |
| PE-5 | 28.0 | 65.4 | 6.6 | 100 | 1.15 |
| PE-6 | 18.7 | 74.7 | 6.6 | 100 | 1.15 |

TABLE 8
Resin Properties of Synthesized Hydroxyl Functional Polyesters

| | | | | Acid | OH |
|---|---|---|---|---|---|
| | | | | Number | Number |
| Polyester | Tg, ° C. | Mn | Mw | Analyzed | Analyzed |
| PE-4 | 64.6 | 3681 | 10720 | 4.8 | 52.2 |
| PE-5 | 49.8 | 3153 | 9763 | 1.0 | 50.5 |
| PE-6 | 41.8 | 3224 | 9364 | 1.2 | 52.5 |

### Example 18

### Preparation of Solvent-Based Formulations Using m-Cresol Based Resole Phenolic Resin

As listed in Table 9, solvent-based formulations were prepared by using the polyesters, PE-4, PE-5, and PE-6, and the resole phenolic resins, Resole 4, Resole 5, Resole 6, and Resole 7. Polyester solutions (35% solids) were first prepared by dissolving the polyester in methyl amyl ketone (MAK). Formulations were then prepared by mixing respectively the polyester solution with a resole phenolic resin (100%) in the presence of an acid catalyst, p-toluenesulfonic acid (pTSA).

TABLE 9
Compositions of Various Formulations

| | Polyester | Resole | pTSA | | |
|---|---|---|---|---|---|
| | (35% in | Resin | (5% in | | |
| Formu- | MAK); | (100%); | isopropanol); | Resin | Catalyst |
| lation | grams | grams | grams | Ratio | Ratio |
| 13 | 10 | 1.5 | 0.5 | 70/30 | 0.5 phr |
| | (PE-4) | Resole 4 | | | (parts per |
| | | | | | hundred of |
| | | | | | resin) |
| 14 | 10 | 1.5 | 0.5 | 70/30 | 0.5 phr |
| | (PE-5) | Resole 4 | | | |
| 15 | 10 | 1.5 | 0.5 | 70/30 | 0.5 phr |
| | (PE-6) | Resole 4 | | | |
| 16 | 10 | 1.5 | 0.5 | 70/30 | 0.5 phr |
| | (PE-4) | Resole 5 | | | |
| 17 | 10 | 1.5 | 0.5 | 70/30 | 0.5 phr |
| | (PE-5) | Resole 5 | | | |
| 18 | 10 | 1.5 | 0.5 | 70/30 | 0.5 phr |
| | (PE-6) | Resole 5 | | | |
| 19 | 10 | 1.5 | 0.5 | 70/30 | 0.5 phr |
| | (PE-4) | Resole 6 | | | |
| 20 | 10 | 1.5 | 0.5 | 70/30 | 0.5 phr |
| | (PE-5) | Resole 6 | | | |
| 21 | 10 | 1.5 | 0.5 | 70/30 | 0.5 phr |
| | (PE-6) | Resole 6 | | | |
| 22 | 10 | 1.5 | 0.5 | 70/30 | 0.5 phr |
| | (PE-4) | Resole 7 | | | |
| 23 | 10 | 1.5 | 0.5 | 70/30 | 0.5 phr |
| | (PE-5) | Resole 7 | | | |
| 24 | 10 | 1.5 | 0.5 | 70/30 | 0.5 phr |
| | (PE-6) | Resole 7 | | | |

### Example 19

### Evaluation of Cured Films by MEK Double Rub Test

Formulations 13-24 prepared in Example 18 were drawn down respectively on electrolytic tin test panels (10 cm×30 cm) using a draw-down bar and subsequently baked in an oven at 205° C. for 10 minutes. The thickness of the coating films was about 10 μm. The degree of crosslinking of the cured films was determined by their solvent resistance using MEK Double Rub Method (ASTM D4752). In the test, the rubbing was stopped when the main body of the film was first exposing the metal, discounting the effect on the end of the rubbed film. The results are collected in Table 10. Typically a result of >30 is considered acceptable and >100 is preferred. The results indicate those based on Resole 5 (formulations 16, 17, and 18) are not cured adequately as the MEK double rubs are significantly lower than others.

TABLE 10
MEK Double Rub Test of the Cured Films from Various Formulations

| | Formulation | | | | | | | | | | | |
|---|---|---|---|---|---|---|---|---|---|---|---|---|
| | 13 | 14 | 15 | 16 | 17 | 18 | 19 | 20 | 21 | 22 | 23 | 24 |
| MEK | 250 | 250 | 280 | 10 | 20 | 20 | 280 | 270 | 230 | 70 | 70 | 60 |
| double | | | | | | | | | | | | |
| rubs | | | | | | | | | | | | |

### Example 20

### Synthesis of Hydroxyl Functional Polyester (PE-7)

A 2-L kettle with a four-neck lid was equipped with a mechanical stirrer, a thermocouple, a heated partial condenser (107° C.), a Dean-Stark trap, and a chilled condenser (15° C.). The kettle was charged with 2,2,4,4-tetramethyl-1,3-cyclobutanediol (TMCD) (313.4 g), 2-methyl-1,3-propanediol (MPDiol) (195.9 g), trimethylolpropane (TMP) (43.21 g); isophthalic acid (IPA) (697.8 g); and the acid catalyst, Fascat-4100 (Arkema Inc.) (1.88 g). The reaction was allowed to react under a nitrogen blanket. The temperature was ramped up from room temperature to 150° C. over 90 minutes. Once reaching the meltdown temperature of 150° C., the temperature was increased from 150 to 230° C. over 3 hours. When the maximum temperature of 230° C. was reached, the reaction was allowed to continue until the theoretical distillate (about 150 g) was collected. The resin was then sampled for acid number analysis with a target of <5 mgKOH/g. After achieving an acid number of 6.4, the resin was allowed to cool to 190° C. before being poured into aluminum pans. The resin was cooled and a solid product collected.

Using the same method as above, PE-8 was synthesized. The relative amounts of the reactants and the results are reported in Tables 11 and 12, wherein Mn is number average molecular weight and Mw is weight average molecular weight.

TABLE 11
Synthesized Hydroxyl Functional Polyesters

| | Resin Composition as Charged | | | | Total eq. |
|---|---|---|---|---|---|
| | Equivalent (eq.) Ratio Based | | | Eq. Ratio Based | of OH/ |
| | on Total Alcohols (%) | | | on Total Diacids (%) | total eq. |
| | TMCD | MPDiol | TMP | IPA | of COOH |
| PE-7 | 45.0 | 45.0 | 10.0 | 100 | 1.15 |
| PE-8 | 45.0 | 45.0 | 10.0 | 100 | 1.10 |

TABLE 12
Resin Properties of Synthesized Hydroxyl Functional Polyesters

| | | | | Acid | OH |
|---|---|---|---|---|---|
| | | | | Number | Number |
| Polyester | Tg, ° C. | Mn | Mw | Analyzed | Analyzed |
| PE-7 | 66.3 | 4692 | 17496 | 4.8 | 45.5 |
| PE-8 | 68.5 | 4472 | 17191 | 11.6 | 35.9 |

### Example 21

### Preparation of Solvent-Based Formulations Using m-Cresol Based Resole Phenolic Resin

As listed in Table 13, solvent-based formulations were prepared by using the polyesters, PE-7 and PE-8, and the resole phenolic resins, Resole 4. Polyester solutions (35% solids) were first prepared by dissolving the polyester in methyl amyl ketone (MAK). Formulations were then prepared by mixing respectively the polyester solution with a resole phenolic resin (100%) in the presence of an acid catalyst, p-toluenesulfonic acid (pTSA). Formulations 25 and 26 contained 0.5 phr (parts per hundred of resin) pTSA, whereas Formulations 27 and 28 contained 1.0 phr.

TABLE 13
Compositions of Various Formulations

| | Polyester | Resole | pTSA | | |
|---|---|---|---|---|---|
| | (35% in | Resin | (5% in | | |
| Formu- | MAK); | (100%); | isopropanol); | Resin | Catalyst |
| lation | grams | grams | grams | Ratio | Ratio |
| 25 | 10 | 1.5 | 0.5 | 70/30 | 0.5 phr |
| | (PE-7) | Resole 4 | | | (parts per |
| | | | | | hundred |
| | | | | | of resin) |
| 26 | 10 | 1.5 | 0.5 | 70/30 | 0.5 phr |
| | (PE-8) | Resole 4 | | | |
| 27 | 10 | 1.5 | 1.0 | 70/30 | 1.0 phr |
| | (PE-7) | Resole 4 | | | |
| 28 | 10 | 1.5 | 1.0 | 70/30 | 1.0 phr |
| | (PE-8) | Resole 4 | | | |

### Example 22

### Evaluation of Coating Properties

Formulations 25-28 prepared in Example 21 were drawn down respectively on electrolytic tin test panels (10 cm×30 cm) using a draw-down bar and subsequently baked in an oven at 205° C. for 10 minutes. The thickness of the coating films was about 10 μm. The degree of crosslinking of the cured films was determined by their solvent resistance using MEK Double Rub Method (ASTM D4752). In the test, the rubbing was stopped when the main body of the film was first exposing the metal, discounting the effect on the end of the rubbed film. The results are collected in Table 14. The results indicate that increasing the amount of pTSA from 0.5 phr to 1.0 phr does not improve coating properties in general.

TABLE 14
Coating Properties

| | | | Water Retort | Acid Retort |
|---|---|---|---|---|
| Formu- | MEK double | Wedge Bend | (20° gloss | (20° gloss |
| lation | rubs | (% fail) | loss) | loss) |
| 25 | 450 | 25 | 17 | 86 |
| 26 | 500 | 25 | 11 | 79 |
| 27 | 200 | 40 | 33 | 28 |
| 28 | 190 | 60 | 94 | 83 |

### Example 23

### Preparation of Solvent-Based Formulations Using m-Cresol Based Resole Phenolic Resin

The examples in Example 21 and 22 were repeated by replacing the pTSA acid catalyst with a phosphoric acid catalyst, CYCAT XK406N (9% active) (available from Allnex) to see its effect on the coating properties. Similar to pTSA, two levels (0.5 phr and 1.0 phr) were used as shown in Table 15.

TABLE 15
Compositions of Various Formulations

| | Polyester | Resole | Catalyst | | |
|---|---|---|---|---|---|
| | (35% in | Resin | wt. CYCAT | | |
| Formu- | MAK); | (100%); | XK406N | Resin | Catalyst |
| lation | grams | grams | (9% active) | Ratio | Ratio |
| 29 | 10 | 1.5 | 0.28 | 70/30 | 0.5 phr |
| | (PE-7) | Resole 4 | | | (parts per |
| | | | | | hundred |
| | | | | | of resin) |
| 30 | 10 | 1.5 | 0.28 | 70/30 | 0.5 phr |
| | (PE-8) | Resole 4 | | | |
| 31 | 10 | 1.5 | 0.56 | 70/30 | 1.0 phr |
| | (PE-7) | Resole 4 | | | |
| 32 | 10 | 1.5 | 0.56 | 70/30 | 1.0 phr |
| | (PE-8) | Resole 4 | | | |

### Example 24

### Evaluation of Coating Properties

Formulations 29-32 prepared in Example 23 were drawn down respectively on electrolytic tin test panels (10 cm×30 cm) using a draw-down bar and subsequently baked in an oven at 205° C. for 10 minutes. The thickness of the coating films was about 10 μm. The degree of crosslinking of the cured films was determined by their solvent resistance using MEK Double Rub Method (ASTM D4752). In the test, the rubbing was stopped when the main body of the film was first exposing the metal, discounting the effect on the end of the rubbed film. The results are collected in Table 16. The results indicate that formulations (31 and 32) based on 1.0 phr phosphoric acid catalyst exhibit significantly better water- and acid-retort resistances than those based on 0.5 phr (29 and 30).

TABLE 16
Coating Properties

| | | | Water Retort | Acid Retort |
|---|---|---|---|---|
| Formu- | MEK double | Wedge Bend | (20° gloss | (20° gloss |
| lation | rubs | (% fail) | loss) | loss) |
| 29 | 500 | 20 | 47 | 40 |
| 30 | 500 | 20 | 58 | 45 |
| 31 | 500 | 20 | 8 | 5 |
| 32 | 500 | 35 | 10 | 7 |

### Example 25

### Synthesis of Etherified Resole Phenolic Resin Based on m-Cresol (HCHO/m-Cresol=2.5 by Mole) (Resole 8)

To a round-bottom flask equipped with a water-jacketed condenser were added m-cresol (97.4 g, 0.9 mole) and formaldehyde (37 wt. % in water) (184 g, 2.25 mole). The pH was adjusted to about 9.8 by dropwise addition of NaOH solution. The resulting homogenous mixture was then placed in 60° C. bath, and stirred at 60° C. under inert atmosphere for 4 hours. After cooling to 0° C., 400 mL water was added, and the pH of the aqueous phase was adjusted to about 7 by addition of dilute HCl. After removal of the solvent using rotary evaporator under reduced pressure, the crude product was dissolved in 300 mL butanol, and the solvent was removed using rotary evaporator under reduced pressure.

The crude resin was dissolved in 500 mL butanol. 50 mL toluene was added. The pH of the mixture was adjusted to around 5.3 by careful addition of phosphoric acid in ethanol. To a round-bottom flask equipped with a Dean-Stark adaptor and a water-jacketed condenser was added the above resole resin solution. The mixture was then allowed to reflux (130° C. bath) for 2 hours. After cooling down, the mixture was subjected to rotary evaporation under reduced pressure to remove most of the solvent. Butanol (150 mL) was added to dissolve the mixture. After suction filtration, the mixture was concentrated using rotary evaporator under reduced pressure to give the final resin 190 g.

### Example 26

### Synthesis of Isopropanol-Etherified Resole Phenolic Resin Based on m-Cresol (HCHO/m-Cresol=2.5 by Mole) (Resole 9)

To a round-bottom flask equipped with a water-jacketed condenser were added m-cresol (97.4 g, 0.9 mole) and formaldehyde (37 wt. % in water) (184 g, 2.25 mole). The pH was adjusted to about 10 by dropwise addition of NaOH solution. The resulting homogenous mixture was then placed in 60° C. bath, and stirred at 60° C. under inert atmosphere for 6 hours. After cooling to 0° C., 400 mL water was added, and the pH of the aqueous phase was adjusted to about 7 by addition of dilute HCl. The upper phase was decanted; the isolated bottom layer was washed with water several times (200 mL×3). The crude product was dissolved in 300 mL butanol, and the solvent was removed using rotary evaporator under reduced pressure.

The crude resin was dissolved in 500 mL butanol. 50 mL toluene was added. The pH of the mixture was adjusted to around 4 by careful addition of phosphoric acid in ethanol. To a round-bottom flask equipped with a Dean-Stark adaptor and a water-jacketed condenser was added the above resole resin solution. The mixture was then allowed to reflux (130° C. bath) for 2 hours. After cooling down, the mixture was subjected to rotary evaporation under reduced pressure to remove most of the solvent. Butanol (150 mL) was added to dissolve the mixture. After suction filtration, the mixture was concentrated using rotary evaporator under reduced pressure to give the final resin 115 g.

### Example 27

### Synthesis of Etherified Resole Phenolic Resin Based on m-Cresol (HCHO/m-Cresol=25 by Mole) (8 Hour Reaction Time) (Resole 10)

To a round-bottom flask equipped with a water-jacketed condenser were added m-cresol (97.4 g, 0.9 mole) and formaldehyde (37 wt. % in water) (184 g, 2.25 mole). The pH was adjusted to about 10 by dropwise addition of NaOH solution. The resulting homogenous mixture was then placed in 60° C. bath, and stirred at 60° C. under inert atmosphere for 8 hours. After cooling to 0° C., 400 mL water was added, and the pH of the aqueous phase was adjusted to about 7 by addition of dilute HCl. The upper phase was decanted; the isolated bottom layer was washed with water several times (200 mL×3). The crude product was dissolved in 300 mL butanol, and the solvent was removed using rotary evaporator under reduced pressure.

The crude resin was dissolved in 500 mL butanol. Toluene (50 mL) was added. The pH of the mixture was adjusted to around 5 by careful addition of phosphoric acid in ethanol. To a round-bottom flask equipped with a Dean-Stark adaptor and a water-jacketed condenser was added the above resole resin solution. The mixture was then allowed to reflux (130° C. bath) for 2 hours. After cooling down, the mixture was subjected to rotary evaporation under reduced pressure to remove most of the solvent. Butanol (150 mL) was added to dissolve the mixture. After suction filtration, the mixture was concentrated using rotary evaporator under reduced pressure to give the final resin 156 g.

### Example 28

### Synthesis of Hydroxyl Functional Polyester (PE-9)

A 2-L kettle with a four-neck lid was equipped with a mechanical stirrer, a thermocouple, a heated partial condenser (107° C.), a Dean-Stark trap, and a chilled condenser (15° C.). The kettle was charged with 2,2,4,4-tetramethyl-1,3-cyclobutanediol (TMCD) (336.4 g), 2-methyl-1,3-propanediol (MPDiol) (210.2 g), trimethylolpropane (TMP) (14.69 g); isophthalic acid (IPA) (348.9 g); 1,4-cyclohexanedicarboxylic acid (CHDA) (361.6 g); and the acid catalyst, Fascat-4100 (Arkema Inc.) (1.88 g). The reaction was allowed to react under a nitrogen blanket. The temperature was ramped up from room temperature to 150° C. over 90 minutes. Once reaching the meltdown temperature of 150° C., the temperature was increased from 150 to 230° C. over 3 hours. When the maximum temperature of 230° C. was reached, the reaction was allowed to continue until the theoretical distillate (about 150 g) was collected. The resin was then sampled for acid number analysis with a target of <5 mgKOH/g. After achieving an acid number of 8.5, the resin was allowed to cool to 190° C. before being poured into aluminum pans. The resin was cooled and a solid product collected.

Using the same method as above, PE-10 was synthesized by replacing CHDA with adipic acid (AD). The relative amounts of the reactants and the results are reported in Tables 17 and 18, wherein Mn is number average molecular weight and Mw is weight average molecular weight.

TABLE 17
Synthesized Hydroxyl Functional Polyesters

| | Resin Composition as Charged | | | | | | Total eq. |
|---|---|---|---|---|---|---|---|
| | Equivalent (eq.) Ratio Based | | | Eq. Ratio Based | | | Of OH/ |
| | on Total Alcohols (%) | | | on Total Diacids (%) | | | total eq. |
| | TMCD | MPDiol | TMP | IPA | CHDA | AD | of COOH |
| PE-9 | 48.3 | 48.3 | 3.4 | 50 | 50 | | 1.15 |
| PE-10 | 48.3 | 48.3 | 3.4 | 50 | | 50 | 1.15 |

TABLE 18
Resin Properties of Synthesized Hydroxyl Functional Polyesters

| | | | | Acid | OH |
|---|---|---|---|---|---|
| | | | | Number | Number |
| Polyester | Tg, ° C. | Mn | Mw | Analyzed | Analyzed |
| PE-9 | 39.8 | 3113 | 7973 | 8.5 | 43.9 |
| PE-10 | 1.5 | 2520 | 8268 | 2 | 53.1 |

### Example 29

### Preparation of Solvent-Based Formulations Using m-Cresol Based Resole Phenolic Resin

As listed in Table 19, solvent-based formulations were prepared by using the polyesters, PE-9, PE-10, and PE-7, and the resole phenolic resins, Resole 10. Polyester solutions (35% solids) were first prepared by dissolving the polyester in methyl amyl ketone (MAK). Formulations were then prepared by mixing respectively the polyester solution with a resole phenolic resin (100%) in the presence of a phosphoric acid catalyst, CYCAT XK406N (9% active).

TABLE 19
Compositions of Various Formulations

| | Polyester | Resole | Catalyst | | |
|---|---|---|---|---|---|
| | (35% in | Resin | wt. CYCAT | | |
| Formu- | MAK); | (100%); | XK406N | Resin | Catalyst |
| lation | grams | grams | (9% active) | Ratio | Ratio |
| 33 | 10 | 1.5 | 0.56 | 70/30 | 1.0 phr |
| | (PE-9) | Resole 10 | | | (parts per |
| | | | | | hundred |
| | | | | | of resin) |
| 34 | 10 | 1.5 | 0.56 | 70/30 | 1.0 phr |
| | (PE-10) | Resole 10 | | | |
| 35 | 10 | 1.5 | 0.56 | 70/30 | 1.0 phr |
| | (PE-7) | Resole 10 | | | |

### Example 30

### Evaluation of Coating Properties

Formulations 33-35 prepared in Example 29 were drawn down respectively on electrolytic tin test panels (10 cm×30 cm) using a draw-down bar and subsequently baked in an oven at 205° C. for 10 minutes. The thickness of the coating films was about 10 μm. The degree of crosslinking of the cured films was determined by their solvent resistance using MEK Double Rub Method (ASTM D4752). In the test, the rubbing was stopped when the main body of the film was first exposing the metal, discounting the effect on the end of the rubbed film. The results are collected in Table 20.

TABLE 20
Coating Properties

| | | | Water Retort | Acid Retort |
|---|---|---|---|---|
| Formu- | MEK double | Wedge Bend | (20° gloss | (20° gloss |
| lation | rubs | (% fail) | loss) | loss) |
| 33 | 500 | 50 | 37 | 30 |
| 34 | 130 | 15 | 18 | 28 |
| 35 | 500 | 10 | 7 | 3 |

The invention has been described in detail with reference to the embodiments disclosed herein, but it will be understood that variations and modifications can be effected within the spirit and scope of the invention.

What we claim is:

1. A resole phenolic resin comprising the residues of
(a) from about 50 to 100 mole % of a meta-substituted phenol [phenolic component (a)],
(b) from 0 to about 50 mole % of at least one phenolic component [phenolic component (b)] other than said meta-substituted phenol, and
(c) from about 150 to about 300 mole % of at least one aldehyde,
wherein the mole percentages of said phenolic components (a) and (b) are based on the total moles of phenolic components (a) and (b);
wherein the mole percentages of said aldehyde component is based on the total moles of said phenolic components (a) and (b), and
wherein said resole phenolic resin is soluble in an organic solvent and curable with a functional polyester.

2. The resole phenolic resin of claim 1, wherein the meta-substituted phenol is one or more selected from the group comprising m-cresol, m-ethylphenol, m-propylphenol, m-butylphenol, m-octylphenol, m-alkylphenol, m-phenylphenol, m-alkoxyphenol, 3,5-xylenol, 3,5-diethyl phenol, 3,5-dibutyl phenol, 3,5-dialkylphenol, 3,5-dialkoxyphenol, 3,5-dicyclohexyl phenol, 3,5-dimethoxy phenol, and 3-alkyl-5-alkyoxy phenol.

3. The resole phenolic resin of claim 1, wherein the meta-substituted phenol of phenolic compound (a) is m-cresol.

4. The resole phenolic resin of claim 1, wherein the phenolic component (b) is ortho-substituted, para-substituted, or unsubstituted phenol, or a mixture thereof.

5. The resole phenolic resin according to claim 1 or 3 comprising phenolic component (b) which is selected from ortho-substituted, or para-substituted phenol, or a mixture thereof.

6. The resole phenolic resin of claim 1, wherein the phenolic component (b) is one or more selected from the group comprising o-cresol, o-ethylphenol, o-propylphenol, o-n-butylphenol, o-t-butyl phenol, o-octylphenol, o-phenylphenol, p-cresol, p-ethylphenol, p-propylphenol, p-n-butylphenol, p-t-butyl phenol, p-octylphenol, p-phenylphenol, 2,3-xylenol, 2,3-diethyl phenol, 2,3-dibutyl phenol, 2,5-xylenol, 2,5-diethyl phenol, 2,5-dibutyl phenol, 3,4-xylenol, 3,4-diethyl phenol, and 3,4-dibutyl phenol.

7. The resole phenolic resin of claim 1, wherein the phenolic component (b) is selected from o-cresol, p-cresol, and a mixture thereof.

8. The resole phenolic resin of claim 1, wherein the aldehyde is selected from formaldehyde, acetaldehyde, propionaldehyde, furfuraldehyde, benzaldehyde, and a mixture thereof.

9. The resole phenolic resin of claim 1, wherein the aldehyde is formaldehyde.

10. The resole phenolic resin of claim 1, which is soluble in one or more organic solvents selected from the group comprising xylene, toluene, acetone, methyl ethyl ketone, methyl isobutyl ketone, methyl n-amyl ketone, methyl isoamyl ketone, n-butyl acetate, isobutyl acetate, t-butyl acetate, n-propyl acetate, isopropyl acetate, ethyl acetate, methyl acetate, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, Aromatic 100 Fluid (ExxonMobil), and Aromatic 150 Fluid (ExxonMobil).

11. The resole phenolic resin of claim 1, wherein the meta-substituted phenol (a) is present in the amount of from 70 to 100 mole % and the phenolic component (b) is present in the amount of from 0 to 30 mole %.

12. The resole phenolic resin of claim 1, wherein the meta-substituted phenol (a) is present in the amount of from 90 to 100 mole % and the phenolic component (b) is present in the amount of from 0 to 10 mole %.

13. The resole phenolic resin of claim 1, wherein the meta-substituted phenol (a) is present in the amount of 100 mole %.

14. The resole phenolic resin of claim 1, wherein the aldehyde is present in the amount of from 170 to 270 mole % of an aldehyde, based on the total moles of phenolic components, (a) and (b).

15. The resole phenolic resin of claim 1, which contains an average of at least 0.5 methylol groups (including either or both of —CH₂OH and —CH₂OR) per one phenolic hydroxyl group.

16. The resole phenolic resin of claim 1, which contains an average of at least 0.7 methylol groups (including either or both of —CH₂OH and —CH₂OR) per one phenolic hydroxyl group.

17. The resole phenolic resin of claim 1, wherein the functional polyester has a functionality selected from hydroxyl, carboxyl, α,β-unsaturated dicarboxylate, beta-ketoacetate, carbamate, phenol, amino, maleimide, and a combination thereof.

18. A thermosetting composition comprising:
I) the resole phenolic resin of claim 1 and
II) a curable polyester which has one or more functionalities selected from the group comprising hydroxyl, carboxyl, α,β-unsaturated dicarboxylate, beta-ketoacetate, carbamate, phenol, amino, and maleimide groups.

19. The thermosetting composition of claim 18 further comprising one or more acid catalysts selected from the group comprising p-toluenesulfonic acid, dinonylnaphthalene disulfonic acid, dodecylbenzenesulfonic acid, and phosphoric acid.

20. The thermosetting composition of claim 18 further comprising phosphoric acid catalyst.

21. The thermosetting composition of claim 18 further comprising phosphoric acid catalyst in an amount ranging from 0.8 to 1.2 weight % based on the total weight of the resole phenolic resin (I) and the curable polyester (II).

22. The thermosetting composition of claim 18, wherein the resole phenolic resin (I) is present in an amount from 20 to 50 weight % and the curable polyester (II) is from 50 to 80 weight % based on the total weight of (I) and (II).

23. The thermosetting composition of claim 18, wherein the curable polyester has a cumulative hydroxyl number and acid number in a range of 3 to 280 mg KOH/g.

24. The thermosetting composition of claim 18, wherein the curable polyester has a cumulative hydroxyl number and acid number in a range of 30 to 150 mg KOH/g.

25. The thermosetting composition of claim 18, wherein the curable polyester has a hydroxyl number ranging from 30 to 150 mg KOH/g.

26. The thermosetting composition of claim 18, wherein the curable polyester has functionalities comprising α,β-unsaturated dicarboxylate group.

27. The thermosetting composition of claim 18, wherein the curable polyester has functionalities comprising beta-ketoacetate group.

28. The thermosetting composition of claim 18, wherein the curable polyester has functionalities comprising carbamate group.

29. The thermosetting composition of claim 18, wherein the curable polyester has functionalities comprising phenol group.

30. The thermosetting composition of claim 18, wherein the curable polyester has functionalities comprising amino group.

31. The thermosetting composition of claim 18, wherein the curable polyester has functionalities comprising maleimide group.

32. The thermosetting composition of claim 18, wherein the curable polyester comprises the residues of
a) polyhydroxyl compounds comprising:
(i) diol compounds in the amount of 70 mole % to 100 mole and
(ii) polyhydroxyl compounds having 3 or more hydroxyl groups in the amount of 0 to 30 mole %,
wherein the mole % is based on 100% of all moles of polyhydroxyl compounds a); and
b) polycarboxyl compounds comprising polycarboxylic acid compounds, derivatives of polycarboxylic acid compounds, the anhydrides of polycarboxylic acids, or combinations thereof.

33. The thermosetting composition of claim 18 further comprising one or more organic solvents selected from the group comprising xylene, toluene, acetone, methyl ethyl ketone, methyl isobutyl ketone, methyl n-amyl ketone, methyl isoamyl ketone, n-butyl acetate, isobutyl acetate, t-butyl acetate, n-propyl acetate, isopropyl acetate, ethyl acetate, methyl acetate, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, Aromatic 100 Fluid (ExxonMobil), and Aromatic 150 Fluid (ExxonMobil).

34. A resole aqueous dispersion comprising
I. the resole phenolic resin of claim 1,
II. a neutralizing agent, and
III. water

35. The resole aqueous dispersion of claim 34, wherein the neutralizing agent is selected from ammonium hydroxide, triethylamine, N,N-dimethylethanolamine, 2-amino-2-methyl-1-propanol, and a mixture thereof.

36. A waterborne thermosetting composition comprising
I. the resole aqueous dispersion of claim 34 and
II. a waterborne curable polyester having one or more functionalities selected from the groups comprising hydroxyl, carboxyl, α,β-unsaturated dicarboxylate, beta-ketoacetate, carbamate, phenol, amino, and maleimide groups.

37. The waterborne thermosetting composition of claim 36, wherein the waterborne curable polyester comprises the residue of 2,2,4,4-tetramethylcyclobutane-1,3-diol (TMCD).

38. A coating made from the thermosetting composition of claim 33 or 36.

39. The thermosetting composition of claim 18 further comprising aminoplast, isocyanate, or epoxy crosslinker.

40. A method for the preparation of the resole phenolic resin of claim 1, comprising the steps of
I. combining meta-substituted phenol and other phenolic compounds if used with formaldehyde water solution (formalin) in a reactor,
II. adjusting the pH of the mixture with a base to be about 9.5 to about 10.5,
III. heating the stirred mixture to a temperature from about 55° C. to about 65° C.,
IV. allowing the mixture to react for about one to about ten hours,
V. neutralizing the resulting mixture upon cooling with an acid to a pH of about 6.5 to about 7.5, and
VI. working up the crude product thus obtained to purify and isolate the resole phenolic resin.

41. The method of claim 40, wherein the pH in (II) is 9.6 to 10.2, the temperature in (III) is 58° C. to about 62° C., and the reaction time in (IV) is two to five hours.
